(19) United States
(12) Patent Application Publication
(10) Pub. No.: US 2026/0289703 A1
(43) Pub. Date: Sep. 24, 2026

(54) SYSTEM

(71) Applicant: SoftBank Group Corp., Tokyo (JP)

(72) Inventor: Toshiyuki NAKATANI, Tokyo (JP)

(73) Assignee: SoftBank Group Corp., Tokyo (JP)

(21) Appl. No.: 19/567,306

(22) Filed: Mar. 16, 2026

(30) Foreign Application Priority Data
Mar. 19, 2025 (JP) 2025-045246

(51) Int. Cl. G06Q 50/18; G06F 16/3329; G06F 16/34

(52) U.S. Cl. CPC G06Q 50/18; G06F 16/33295; G06F 16/345

(57) ABSTRACT

A system includes a processor that is configured to learn, using court precedents as a dataset, and generate a prompt for a generative AI model in order to provide advice regarding a legal issue of a user, analyze an emotional state of the user and adjust the legal advice based on the emotional state, and introduce a reliable legal professional when it is determined that a probability of a successful outcome is high.

### CROSS-REFERENCE TO RELATED APPLICATION

This application is based on and claims priority under 35 USC 119 from Japanese Patent Application No. 2025-045246 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional legal consultation systems and online legal information services primarily focus on static retrieval of legal documents or simple question-and-answer interactions, and therefore fail to provide advice that is (i) grounded in patterns learned from court precedents, (ii) dynamically adapted to the emotional state of the user, and (iii) efficiently connected to reliable legal professionals when litigation is likely to be successful. As a result, users may receive generic or overly formal advice that does not reflect case outcome tendencies, may feel misunderstood or stressed because their emotional condition is not considered, and may have difficulty identifying trustworthy legal professionals at the time when professional representation is most beneficial. Furthermore, known systems often lack integrated mechanisms for secure communication and data protection tailored to sensitive legal information. Accordingly, there is a need for a system that can (1) leverage a dataset of court precedents to generate context-aware legal advice through a generative AI model, (2) analyze and respond to the user's emotional state in order to adjust the style and content of the legal advice, (3) recommend reliable legal professionals based on an estimated probability of success, and (4) securely transmit and receive user input by employing encryption technology.

### SUMMARY

In order to solve the above-described problems, according to one aspect of the present invention, there is provided a system comprising a processor, wherein the processor is configured to learn, using court precedents as a dataset, and generate a prompt for a generative AI model in order to provide advice regarding a legal issue of a user, analyze an emotional state of the user and adjust the legal advice based on the emotional state, and introduce a reliable legal professional when it is determined that a probability of a successful outcome is high. In one embodiment, the processor is configured to analyze a situation description received from the user by using natural language processing and propose an optimal solution by using the generative AI model, such that the generated advice reflects factual patterns, typical outcomes, and legal reasoning observed in the precedent dataset. In another embodiment, the processor is configured to protect data by using encryption technology in order to securely transmit and receive input from the user, thereby maintaining confidentiality and integrity of sensitive legal information. By combining precedent-based learning, emotional state analysis, generative AI advice, controlled introduction of legal professionals triggered by a high success probability, and secure communication, the system provides personalized, context-aware, and trustworthy legal support.

The term “system” refers to an arrangement of hardware components, software components, or a combination thereof, configured to execute one or more processes related to providing legal advice and associated functions.

The term “processor” refers to one or more hardware processing units, such as a central processing unit (CPU), a graphics processing unit (GPU), a microcontroller, or any combination thereof, capable of executing instructions to perform the functions described in the present specification and claims.

The term “court precedents” refers to collections of past judicial decisions, case records, opinions, judgments, or related legal documents issued by courts, which are used as a dataset for training or configuring a model to recognize patterns in legal outcomes and reasoning.

The term “dataset” refers to a structured or unstructured collection of data, including but not limited to text, annotations, and labels, that is used for training, validating, or operating a machine learning model or generative AI model.

The term “generative AI model” refers to a machine learning model, such as a neural network or other statistical model, configured to generate text or other content in response to an input prompt, based on patterns learned from training data.

The term “prompt” refers to an input sequence, query, or set of structured or unstructured data provided to a generative AI model, which guides or conditions the content generated by the generative AI model.

The term “legal issue of a user” refers to a problem, dispute, question, or situation involving rights, obligations, or responsibilities under laws or regulations, as experienced or described by the user.

The term “advice regarding a legal issue” refers to information, guidance, suggestions, or indicative strategies related to how the user may understand, address, or resolve the legal issue, without necessarily constituting formal legal representation.

The term “emotional state of the user” refers to a psychological or affective condition of the user, such as stress, anxiety, anger, confusion, or calmness, inferred from user inputs including text, voice, behavior, or other signals.

The term “adjust the legal advice based on the emotional state” refers to modifying, tailoring, or customizing the content, tone, detail level, or presentation style of the legal advice in accordance with the detected emotional state of the user, so as to improve understandability, comfort, or appropriateness.

The term “probability of a successful outcome” refers to an estimated likelihood, expressed as a numerical value or qualitative indicator, that a legal claim or action by the user will result in a favorable decision, settlement, or other beneficial resolution.

The term “reliable legal professional” refers to a lawyer, attorney, legal advisor, or other qualified legal expert, who satisfies one or more criteria relating to trustworthiness, competence, experience, certification, reputation, or performance, and who is deemed suitable for introduction to the user.

The term “situation description received from the user” refers to a text, voice, or otherwise expressed narrative, explanation, or statement provided by the user, describing factual circumstances, background, or context related to the legal issue.

The term “natural language processing” refers to computational techniques and algorithms for analyzing, interpreting, transforming, or generating human language in textual or spoken form, including but not limited to tokenization, parsing, classification, entity recognition, and semantic analysis.

The term “optimal solution” refers to a recommended course of action, strategy, or set of options that is determined, based on predefined criteria or learned patterns, to be suitable or advantageous for addressing the user's legal issue under the given circumstances.

The term “protect data by using encryption technology” refers to applying one or more cryptographic methods to transform data into a form that is unintelligible to unauthorized parties, so as to ensure confidentiality, and optionally integrity and authenticity, during storage or transmission.

The term “securely transmit and receive input from the user” refers to sending and receiving user data over a communication channel that is protected against unauthorized access, interception, modification, or disclosure, for example by using encryption protocols such as SSL/TLS or equivalent technologies.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

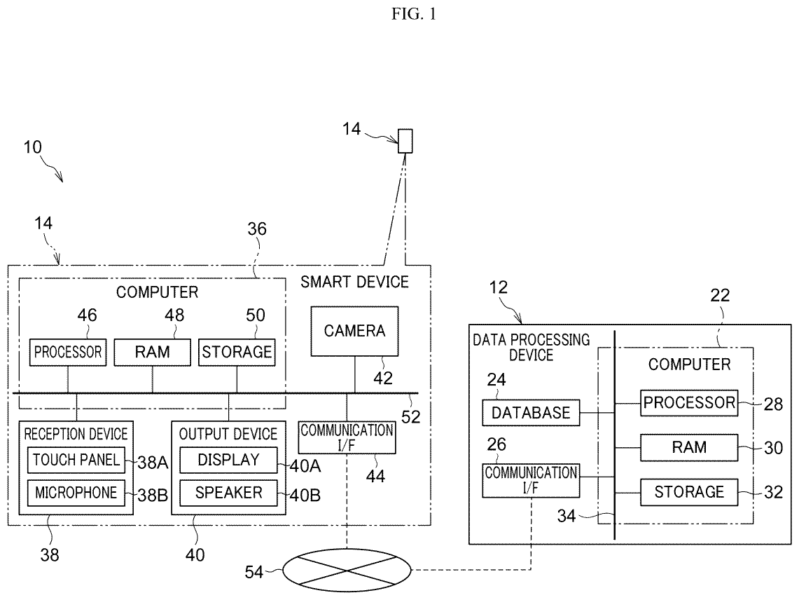

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

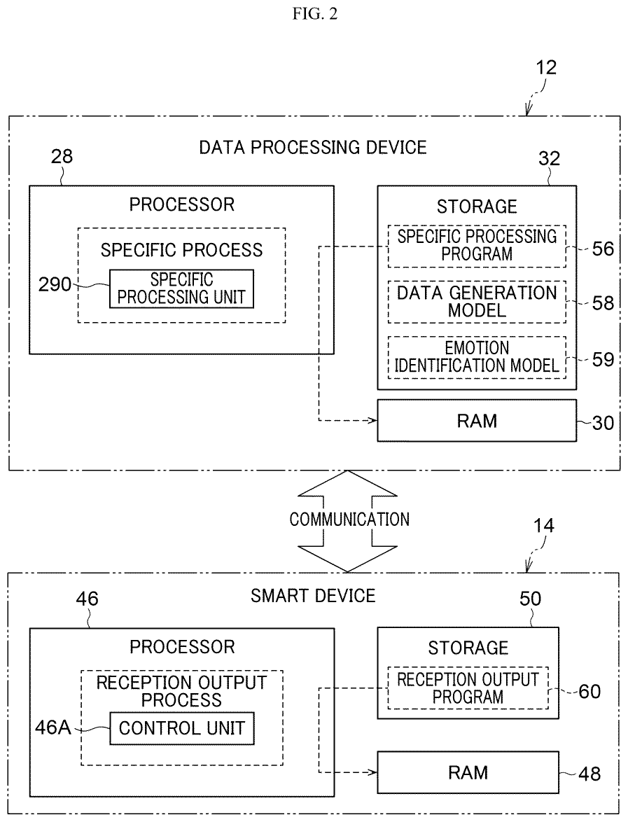

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented legal assistance systems are typically configured to apply fixed rule sets or simple pattern matching to user inputs describing legal issues. Such systems suffer from multiple technical limitations in terms of information processing performance and quality of generated outputs. First, conventional systems often treat a user's natural language query as an unstructured string and do not convert it into an optimized internal representation that is suitable for large-scale retrieval and generation. As a result, retrieval of relevant judicial decisions from large document collections is inefficient and inaccurate, causing unnecessary computational load and latency in server-side processing.

Second, in many existing systems, a generative model, if used at all, is invoked with ad hoc, unstructured prompts that do not reflect the semantic features of the user's query, the classification of the legal domain, or the summarized content of related judicial decisions. This leads to unstable generation behavior, redundant or irrelevant output, and increased token usage, thereby degrading the efficiency of model inference and the consistency of generated advice. From the standpoint of computer technology, the absence of a structured and dynamically constructed prompt format wastes learned representations in the generative model and results in suboptimal utilization of processing resources.

Third, known systems frequently fail to integrate similarity-based retrieval of prior judicial decisions with generative processing in a unified inference pipeline. In many cases, retrieval and generation are executed as separate, loosely coupled processes, or retrieval is omitted entirely. This separation prevents the server from efficiently narrowing the candidate decision set based on high-dimensional numerical representations of the user's query, and causes the generative model to operate without access to the most relevant contextual information. Consequently, server hardware must process larger search spaces and longer prompts, which negatively affects throughput and scalability.

Fourth, conventional systems generally do not adapt response tone or level of detail to the user's emotional state at the level of prompt construction for the generative model. Any attempt to adapt the tone is often implemented as a post-processing filter on the generated output. This approach does not influence the internal token prediction process of the generative model and therefore cannot efficiently control the generation behavior at its source. From a technical perspective, the lack of emotion-aware conditioning within the prompt reduces control over the generative process and may require repeated generation, consuming additional computation cycles.

Fifth, existing systems typically treat the decision of whether to introduce a human legal practitioner as a purely business rule outside the main inference flow. They do not compute a machine-readable legal risk or dispute complexity score derived from the generated response and the user's numerical representation, and thus cannot perform efficient branching in the server-side logic based on a unified internal metric. This lack of integration leads to redundant data handling and separate evaluation paths, which complicate the server architecture and reduce maintainability and extensibility.

Accordingly, there is a need for improved computer technology that (i) converts natural language legal queries into structured numerical representations, (ii) performs similarity-based retrieval of past judicial decisions in a large-scale document collection, (iii) dynamically constructs a prompt sentence having a defined structure that combines extracted keywords, legal domain classification, and summarized decision information, (iv) conditions a generative AI model on that structured prompt to generate advice, (v) evaluates legal risk and dispute complexity using internal model outputs, and (vi) optionally appends expert information and emotion-aware instructions within the same processing pipeline. Such a configuration is expected to improve the technical performance of a server-based legal assistance system in terms of response accuracy, inference efficiency, controllability of generated content, and scalability when operating on large datasets and complex user inputs.

The specific processing by the specific processing unit 290 of the data processing device 12 in Example 1 is realized by the following means.

The present invention provides a server comprising a processor and a storage device in which the storage device stores instructions that, when executed by the processor, cause the processor to obtain, from the storage device, a group of information including document information comprising past judicial decisions as learning information, and to train, by using a machine learning platform, a generative AI model based on a statistical learning method so as to generate internal legal knowledge representations corresponding to the document information; to receive, from a communication terminal, explanation information in natural language regarding a legal issue input by a user, and to normalize the explanation information, divide the explanation information into units of words or subwords, extract important words and important phrases, convert the explanation information into a numerical representation, and classify a legal field category corresponding to the explanation information by using a natural language processing technique; to retrieve, on the basis of the numerical representation, a plurality of related judicial decision information by using similarity between the numerical representation and numerical representations stored in association with the document information comprising the past judicial decisions, to generate summary information of the related judicial decision information, and to construct a prompt sentence having a predefined prompt structure including at least the important words, the legal field category, the summary information of the related judicial decision information, and constraint conditions regarding a response format; to input the constructed prompt sentence as input information to the generative AI model, to cause the generative AI model to generate a response sentence including advice information regarding the legal issue of the user, to evaluate a legal risk or a dispute complexity on the basis of at least the response sentence and the numerical representation, and, when a predetermined condition relating to the legal risk or the dispute complexity is satisfied, to obtain expert information from a legal practitioner information storage unit that stores information of legal practitioners having a professional qualification and append the expert information to the advice information; to perform, for the explanation information, an emotional state estimation process based on an emotion analysis technique, to modify instruction content in the prompt sentence regarding a response tone or a level of explanation detail according to an estimated emotional state, thereby controlling an expression style of the advice information generated by the generative AI model; and to generate response information including at least the response sentence and, when obtained, the expert information and to transmit the response information to the communication terminal through an encrypted communication channel. This enables the server to improve internal information processing efficiency, retrieval accuracy, and generation controllability by integrating similarity-based retrieval and dynamically structured prompt construction into a single inference pipeline, to adapt the generative AI model's behavior to both semantic and emotional characteristics of the user's input, and to provide legally contextualized outputs with controlled content and format while maintaining scalability and robustness when operating on large collections of judicial decision data.

The term “processor” refers to a hardware computation unit, such as a central processing unit or an accelerator, that executes instructions to perform arithmetic and logical operations, data transfer operations, and control operations.

The term “storage unit” refers to a hardware memory resource, such as a semiconductor memory device or a magnetic or optical storage device, that stores data, models, and program instructions used by the processor.

The term “group of information” refers to a collection of multiple data items, including but not limited to text data, numerical data, and metadata, that are related to each other for processing as a set.

The term “document information” refers to digital data representing text-based content, such as judgments, opinions, reasons, and associated legal materials, that can be processed by a computer.

The term “past judicial decisions” refers to records of previously decided legal cases, including judgments and reasoning issued by adjudicative bodies, which can be used as reference information for legal analysis.

The term “learning information” refers to data used for training or updating a machine learning model, including input-output pairs, labels, and annotations, that enable the model to learn patterns and relationships.

The term “generative AI model” refers to a machine learning model configured to generate new data, such as text sequences, by predicting or sampling outputs based on learned probability distributions from training data.

The term “statistical learning method” refers to a computational approach for training models that estimate parameters using statistical techniques, such as gradient-based optimization, to minimize a loss function defined over training data.

The term “machine learning platform” refers to a software and hardware environment that provides libraries, frameworks, and runtime components enabling the construction, training, evaluation, and deployment of machine learning models.

The term “legal knowledge representations” refers to internal data structures, such as vectors, embeddings, or parameterized features, that capture semantic relationships and patterns derived from legal documents and judicial decisions.

The term “communication terminal” refers to an electronic device, such as a mobile device, a personal computer, or another network-connected apparatus, that transmits user input to a server and receives responses from the server.

The term “explanation information” refers to natural language text provided by a user describing a legal issue, situation, or question, which is processed by the system to generate advice.

The term “normalize” refers to processing operations that convert input text into a standardized form, including operations such as unifying character formats, adjusting punctuation, and applying consistent casing, to facilitate subsequent analysis.

The term “units of words or subwords” refers to granular linguistic tokens obtained by segmenting a text into words, morphemes, or smaller subword segments used as basic elements for natural language processing.

The term “important words and important phrases” refers to tokens or sequences of tokens that are determined, by statistical, heuristic, or learned criteria, to be highly relevant to the meaning or classification of a user's explanation information.

The term “numerical representation” refers to a machine-readable encoding of text or other data in the form of numerical values, such as vectors or matrices, suitable for computation in machine learning models.

The term “legal field category” refers to a classification label indicating a legal domain, such as contract law, property law, or labor law, that characterizes the main subject matter of a user's explanation information.

The term “natural language processing technique” refers to a computational method for analyzing, transforming, or generating human language text, including tokenization, tagging, parsing, embedding generation, and semantic analysis.

The term “retrieve” refers to the operation of selecting data items from a data store or index based on a query, condition, or similarity measure, and returning the selected items for further processing.

The term “similarity” refers to a quantitative measure of closeness between two numerical representations, such as vectors, computed by a distance metric or similarity function.

The term “numerical representations stored in association” refers to numerical encodings of document information that are stored together with identifiers or indexes linking them to corresponding original documents.

The term “related judicial decision information” refers to judicial decision data selected from stored judicial decisions because their numerical representations are similar to the numerical representation of the user's explanation information.

The term “summary information” refers to condensed textual or structured content derived from longer documents, which captures the main points or reasoning of judicial decisions in a reduced form.

The term “prompt sentence” refers to a text sequence provided as input to a generative AI model, including instructions, user queries, context, and other information that condition the model's generation behavior.

The term “prompt sentence structure” refers to a predefined template or logical arrangement of components in a prompt sentence, such as instruction sections, user question sections, keyword sections, and summary sections.

The term “constraint conditions regarding a response format” refers to rules or parameters specifying desired characteristics of a generated response, such as length, style, tone, language, or structural format.

The term “input information” refers to data, including prompt sentences or numerical representations, that is provided to a model or processing module for computation and output generation.

The term “response sentence” refers to a text string generated by the generative AI model that includes advice, explanations, or recommendations corresponding to the user's legal issue.

The term “advice information” refers to content in the response sentence that provides suggested actions, interpretations, or guidance regarding the legal issue described by the user.

The term “legal risk” refers to a quantified or categorized assessment of potential adverse legal consequences, such as liability, sanctions, or unfavorable judgment, based on the user's situation and generated analysis.

The term “dispute complexity” refers to an assessment of the difficulty or intricacy of a legal dispute, considering factors such as the number of issues, applicable laws, evidence volume, and procedural posture.

The term “predetermined condition” refers to a rule or threshold defined in advance, such as a risk score boundary or complexity level, that determines whether a particular processing branch, such as expert recommendation, is executed.

The term “legal practitioner information storage unit” refers to a storage device or data structure that maintains records of legal professionals, including their qualifications, specialties, and contact details.

The term “expert information” refers to data describing one or more legal practitioners, such as areas of expertise and contact information, which can be attached to advice information for referral purposes.

The term “emotional state estimation process” refers to computational analysis of text or other input to infer a user's emotional condition, such as anxiety, anger, or calmness, using emotion classification or sentiment analysis techniques.

The term “emotion analysis technique” refers to a machine learning or rule-based method for detecting, classifying, or scoring emotional content in user-provided text or other signals.

The term “instruction content in the prompt sentence” refers to portions of a prompt sentence that direct the generative AI model regarding how to respond, including instructions about tone, detail, structure, or perspective.

The term “response tone” refers to the stylistic and affective qualities of a generated response, such as formality, empathy, directness, or reassurance, as expressed in the wording and phrasing.

The term “level of explanation detail” refers to the degree of granularity, depth, and comprehensiveness in a generated explanation, ranging from high-level summaries to step-by-step or technical descriptions.

The term “expression style” refers to the manner in which content is linguistically expressed, including tone, formality, complexity, and organization of the text.

The term “response information” refers to a data structure or message that includes the response sentence and, when applicable, expert information and other associated metadata for presentation to the user.

The term “encrypted communication” refers to a transmission method in which data is transformed by a cryptographic algorithm so that it is unintelligible to unauthorized entities during transfer between the server and the communication terminal.

In one embodiment, a server operates as an information processing apparatus that cooperates with one or more terminals used by a user. The server includes at least one processor, a main memory, a nonvolatile storage device, and a network interface. The server executes an operating system such as a server-class operating system, and application software including a web application framework, a database management system, and a machine learning platform such as a deep learning framework. The terminal includes, for example, a smartphone, a tablet, or a personal computer executing a client application or a web browser, and is connected to the server via a network using a secure communication protocol.

The server uses a storage device to store a corpus of document information that includes past judicial decisions, associated metadata, and precomputed numerical representations. The server also stores trained parameters of a generative AI model, configuration data defining a prompt sentence structure, and a database of legal practitioner information. The server maintains these data in structured data stores such as relational databases and vector indexes, and in model repositories as parameter files.

The server uses a machine learning platform, such as a general-purpose deep learning framework, to implement the generative AI model and related models. The server configures the generative AI model as a neural network having a transformer-based architecture, including an input embedding layer, a plurality of self-attention layers, feedforward layers, and an output projection layer. The server defines hyperparameters of the model such as the number of layers, the number of attention heads, the dimensionality of hidden states, and the size of the output vocabulary. The server uses a tokenizer component that segments text into subword units based on a learned subword vocabulary, and that maps subword tokens to integer token IDs.

The server trains the generative AI model on document information including past judicial decisions by executing training processes on graphical processing units or central processing units. The server converts training documents into sequences of token IDs using the tokenizer. The server segments the sequences into fixed-length or variable-length training examples and constructs input-output pairs where a portion of the sequence is used as context and a subsequent portion is used as target output. The server defines a loss function such as a cross-entropy loss between predicted token distributions and ground-truth tokens, and uses an optimization algorithm such as a variant of stochastic gradient descent with adaptive moment estimation to update model weights. The server performs forward propagation to compute predicted token probabilities, computes the loss, and performs backpropagation to update the parameters of the attention layers, feedforward layers, and embedding layers. The server may also apply regularization techniques such as dropout and weight decay during training.

The server generates and stores numerical representations (embeddings) of judicial decision documents by using an encoder network that may share parameters with or be separate from the generative AI model. The server applies a pooling operation, such as mean pooling or [CLS]-token pooling, to obtain a fixed-length vector representation for each document. The server stores these vector representations in a vector index data structure that supports similarity search such as an approximate nearest neighbor index, and associates each vector with a document identifier and metadata. The server thereby configures a retrieval module that can efficiently find related judicial decisions for a given query representation.

The server uses a natural language processing pipeline to process explanation information provided by the user. The server first normalizes the text by performing operations such as Unicode normalization, standardization of punctuation, and transformation of characters to a unified format. The server then applies the tokenizer to segment the explanation information into subword tokens and to convert those tokens into token IDs. The server optionally applies part-of-speech tagging and named entity recognition using statistical or neural models to identify entities such as parties, contract types, assets, or monetary amounts. The server computes an embedding for the explanation information using the encoder network, thereby obtaining a numerical representation that captures semantic content.

The server classifies the explanation information into a legal field category by inputting the numerical representation into a classifier network, which may be implemented as a shallow neural network or as a linear classification layer applied on top of the encoder output. The server uses a training dataset where explanation-like texts are labeled with legal domains such as contract law, property law, or labor law, and optimizes classifier parameters using a supervised learning procedure with a classification loss function. By performing this classification, the server reduces the search space for retrieval and constrains the context provided to the generative AI model.

The server retrieves related judicial decision information by submitting the numerical representation of the explanation information to the vector index and computing similarity scores such as cosine similarity or inner product between the query vector and stored document vectors. The server selects a set of top-ranked decisions based on similarity values. The server then accesses metadata and full texts of the selected decisions from the document store. The server may execute a summarization algorithm implemented as an additional neural network or as a rule-based extraction module to generate summary information for each selected decision. For example, the server may use a transformer-based summarization model trained to produce concise abstracts from judicial opinions, or the server may identify and extract sentences that contain key legal findings and outcomes.

The server constructs a prompt sentence for the generative AI model by assembling multiple components into a structured template. The server defines a prompt sentence structure that includes at least a section describing the role of the model, a section containing the user's question, a list of extracted important words, the legal field category, a list of relevant judicial decision summaries, and explicit instructions regarding response style and limitations. The server fills each section with relevant content, ensuring that the resulting text respects predefined length constraints and ordering rules that are optimized for stable model behavior. The server thereby controls the internal attention patterns of the generative model by providing contextual segments that the model can attend to selectively.

In one concrete example, the server generates a prompt sentence as follows:

You are a legal information assistant using a generative AI model trained on judicial decisions.

User question:

“Please tell me how to resolve a dispute regarding a real estate contract.”

Extracted keywords: [“real estate”, “contract”, “dispute”, “breach”, “termination”]

Legal category: Contract law/Real estate

Relevant case summaries:
1. Case A: In a dispute over a real estate sale agreement, the adjudicating body allowed termination after written notice when the buyer failed to pay within the agreed period.
2. Case B: In a dispute over a lease, the adjudicating body reduced the rent due to property defects and encouraged negotiation between the parties.

Instructions:
Provide general, non-binding legal information.
Explain practical steps the user can take.
Refer to typical legal principles indicated in the case summaries.
Advise the user to consult a licensed legal practitioner for formal legal advice.

Answer in English.

The server converts the prompt sentence into token IDs using the tokenizer associated with the generative AI model. The server then inputs the token IDs into the generative AI model. The model applies multi-head self-attention in each transformer layer, where each attention head computes attention scores between tokens based on query, key, and value projections of the hidden states. The server obtains the output distribution over vocabulary tokens at each position by applying the output projection layer and a softmax function. The server controls output generation using decoding algorithms such as greedy decoding, beam search, or nucleus sampling, and restricts maximum output length and sampling parameters to balance diversity and reliability.

The server decodes the generated token sequence back into text to produce a response sentence. The server may apply post-processing rules to correct spacing, punctuation, or undesirable patterns. The server then performs a risk and complexity assessment based on both the numerical representation of the user's explanation and the generated response sentence. The server may use an additional neural network that takes as input a concatenation of the query embedding and an embedding of the response text, and outputs a risk score and a complexity score. The server calibrates thresholds for these scores using validation data. If the scores meet predetermined conditions, such as exceeding a risk threshold or a complexity threshold, the server queries the legal practitioner information storage unit to obtain expert information matching the legal field category and, where available, the geographic or subject-matter constraints inferred from the explanation information.

The server integrates the expert information with the response sentence to form combined advice information. The server may append a section such as “It is advisable to consult a legal practitioner specializing in [field]” followed by a generic description of practitioner attributes or, in some implementations, specific contact options consistent with data protection policies. The server also incorporates a disclaimer segment in the response information to indicate that the generated text is informational and not a substitute for professional representation.

The server further performs an emotional state estimation process on the explanation information. The server uses an emotion analysis technique implemented as a neural network classifier trained on text labeled with emotional categories or sentiment scores. The server encodes the explanation text with an encoder network and feeds the resulting embedding into a classifier that outputs probabilities for states such as anxious, neutral, or angry. Based on the estimated state, the server modifies portions of the prompt sentence that instruct the generative AI model regarding tone and level of detail. For example, for an anxious state, the server may include instructions such as “Use a calm and reassuring tone” and “Provide step-by-step explanations,” while for a neutral state, the server may specify a more concise and formal tone. By changing prompt-level instructions before generation, the server directly influences the internal attention and token selection behavior of the generative model rather than merely filtering the output afterward.

The server transmits response information to the terminal via encrypted communication using protocols such as Transport Layer Security. The server packages the response sentence, any attached expert information, and metadata into a structured message. The terminal receives this message, decodes it, and presents the content on a display. The terminal may render the advice text in a formatted view, separate the main advice, risk indicators, and referrals, and allow the user to scroll, save, or initiate follow-up actions.

The server achieves technical effects in several ways. By representing both user queries and judicial decisions as high-dimensional numerical vectors and using similarity search structures, the server reduces the retrieval search space and response latency compared with naive keyword search methods. The server thereby improves processing speed and scalability when operating on large document collections. By constructing a structured prompt sentence that deliberately combines extracted keywords, legal field category information, and summarized decisions, the server stabilizes the context provided to the generative AI model, which improves consistency and relevance of the generated responses and reduces the average number of tokens required to obtain useful answers. This in turn lowers computation time and memory utilization per request, improving throughput on shared hardware resources.

The server further improves accuracy and control by integrating risk scoring and emotion analysis into the same computational pipeline that handles representation learning and generation. The server uses unified embeddings and classifier outputs to decide whether to attach expert information and how to adjust tone and detail. This integrated architecture avoids separate, duplicative data processing stages and allows weight sharing between models, reducing memory footprint and improving cache locality during execution. The use of emotion-conditioned prompt construction changes the generative model behavior at the level of attention weights and token probabilities, which is technically different from human post-editing or simple rule-based text transformation.

The server also departs from conventional rule-based expert systems by exploiting learned high-dimensional relationships between queries and decisions. Human operators reading and comparing judicial decisions cannot operate in a vector space with precomputed similarity metrics and do not dynamically construct prompt sentences that encode classifier outputs and retrieval results as conditional instructions for a multi-layer neural network. The server uses nonintuitive combinations of embedding-based retrieval, transformer-based generation, and dynamic prompt engineering to achieve improved precision and efficiency. Because the server conditions the generative AI model on compact, relevance-optimized summaries rather than full decision texts, the server reduces communication and computation load inside the neural network while preserving essential legal content, which leads to faster inference and lower error rates due to context overload.

In alternative embodiments, the server may adopt different encoder architectures, such as recurrent networks or convolutional networks, for computing numerical representations, or may use different similarity measures or indexing structures to implement retrieval. The generative AI model may be trained with additional objectives, such as masked language modeling or contrastive learning, to improve robustness. The emotion analysis module may be replaced or supplemented by multimodal analysis if the terminal supplies voice or facial expression data, provided that such data are converted into numerical features. The server may also adjust prompt sentence structure according to the type of legal domain, for example including specific subsections for statutory text excerpts in certain fields, or varying the number of retrieved decisions included in the context.

In another embodiment, the terminal may perform a subset of preprocessing, such as initial tokenization or language detection, and transmit partially processed data to the server to reduce bandwidth or latency. The server in that case still performs core operations of numerical representation learning, similarity search, structured prompt construction, and generative inference. The division of labor between server and terminal can be configured based on hardware capabilities and network conditions, but the essential architecture remains centered on the server-side improvement of retrieval, generation, and control as described above.

Through these configurations and variations, the server uses specific data structures, neural network architectures, and algorithmic flows that improve computer-based legal information processing beyond mere automation of human reading and drafting. The server thereby enhances technical performance in terms of retrieval accuracy, generation quality, processing speed, and resource utilization while providing structured, controllable advice information to the user via the terminal.

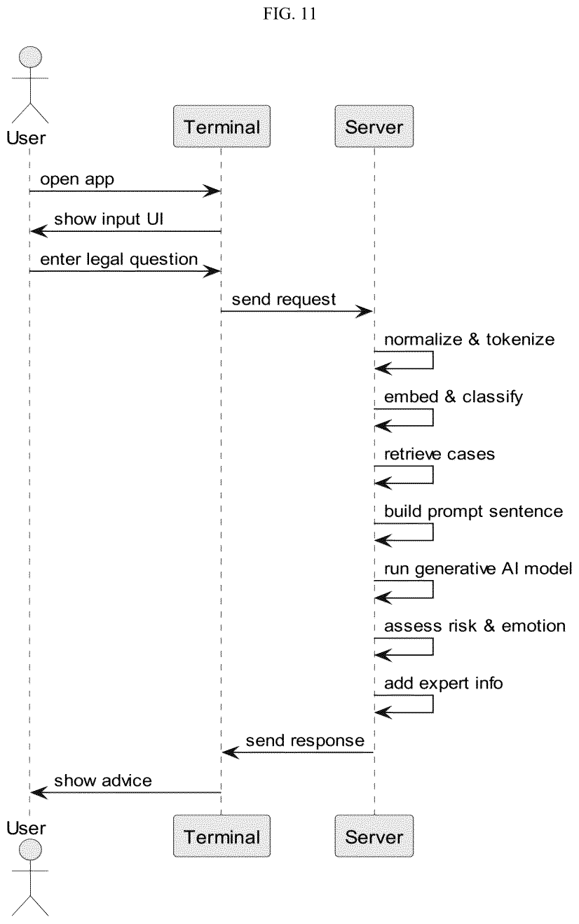

The following describes the processing flow using FIG. 11.

### Step 1:

The user operates the terminal to start a legal consultation application or open a web page provided by the server.
The input is a user action such as tapping an application icon or accessing a URL.
The terminal processes this input by launching an application process or loading an initial web page from the server, and the output is a display screen that includes a text input area and a submit control for entering a legal issue.

### Step 2:

The user inputs explanation information describing a legal issue into the terminal in natural language.
The input is a sequence of characters typed or dictated by the user, for example: “Please tell me how to resolve a dispute regarding a real estate contract.”
The terminal converts the user's keystrokes or speech into text data, associates metadata such as a timestamp, language setting, and session identifier, and the output is a structured request object containing the raw text and metadata.

### Step 3:

The terminal sends the structured request object to the server via an encrypted communication channel.
The input is the request object containing the explanation text and metadata.
The terminal performs data serialization (for example, converting the object into a JSON or similar format), establishes a secure connection using a transport security protocol, and transmits the serialized data. The output is an encrypted network message delivered to the server.

### Step 4:

The server receives the encrypted network message and reconstructs the structured request object.
The input is the encrypted message arriving at the network interface.
The server decrypts the message using the negotiated security protocol, parses the data format to extract fields such as the raw explanation text, language, and session ID, and stores a log record in a persistent store. The output is an internal data structure representing the user's explanation information and associated metadata.

### Step 5:

The server normalizes the explanation information and tokenizes it into units of words or subwords.
The input is the explanation text string.
The server applies text normalization operations such as Unicode normalization, punctuation standardization, and case conversion where appropriate, then applies a tokenizer that segments the text into tokens and maps each token to a token ID based on a vocabulary. The data processing involves scanning the character sequence, matching subword patterns, and generating an ordered list of token IDs. The output is a normalized text string and an ordered sequence of tokens and token IDs.

### Step 6:

The server extracts important words and phrases and generates an initial numerical representation of the explanation information.
The input is the token sequence and token IDs from Step 5.
The server applies a natural language processing pipeline that may include part-of-speech tagging and entity recognition to identify candidate keywords, then scores tokens and token spans using statistical measures or model-based attention weights to select important words and phrases. The server feeds the token IDs into an encoder network to compute hidden state vectors and applies a pooling operation to obtain a fixed-length embedding. The output is a set of important words and phrases and a first numerical representation (embedding vector) of the explanation information.

### Step 7:

The server classifies the legal field category corresponding to the explanation information.
The input is the numerical representation from Step 6.
The server forwards the embedding through a classifier, for example a fully connected neural layer followed by a softmax operation, and computes probability scores for multiple legal categories. The server selects the category with the highest probability or a set of categories above a threshold. The output is at least one legal field category label associated with the explanation information.

### Step 8:

The server retrieves related judicial decision information using similarity search in a vector index.
The input is the numerical representation from Step 6 and optional legal field constraints from Step 7.
The server queries a vector index by computing similarity scores, such as cosine similarity, between the query embedding and stored document embeddings, restricts the search to documents belonging to the same or related legal categories if configured, and selects top-ranked document identifiers. The output is a list of related judicial decision identifiers and associated similarity scores.

### Step 9:

The server obtains full texts and metadata of the related judicial decisions and generates summary information.
The input is the list of related decision identifiers from Step 8.
The server queries a document store to retrieve decision texts, headings, judgment dates, and other metadata, then applies a summarization process, such as sentence extraction or a summarization model, to condense each decision into a short summary. The server analyzes sentence-level features or model attention scores to select legally significant portions. The output is a collection of structured items, each including a decision identifier, metadata, and summary information.

### Step 10:

The server constructs a structured prompt sentence for the generative AI model.
The input is the user's explanation text, the set of important words and phrases, the legal field category, and the summary information of related decisions.
The server fills a predefined prompt template that includes segments for model role description, user question, keyword list, legal category label, decision summaries, and response instructions. The server concatenates these segments into a coherent text while enforcing length and ordering rules, thereby performing string assembly operations based on the input components. The output is a complete prompt sentence in natural language.

### Step 11:

The server encodes the prompt sentence into token IDs suitable for the generative AI model.

The input is the prompt sentence text from Step 10.

The server applies the tokenizer associated with the generative AI model, segments the prompt into subword tokens, maps tokens to token IDs, and constructs position encodings or other auxiliary inputs required by the transformer architecture. The data processing consists of token lookup in a vocabulary table and generation of numerical arrays representing the token sequence. The output is a sequence of token IDs and related model input tensors.

### Step 12:

The server generates a response sentence including advice information by executing the generative AI model.
The input is the sequence of token IDs and model input tensors from Step 11.
The server loads the model parameters into memory if not already loaded, then performs forward propagation through the transformer layers. Each layer computes query, key, and value vectors, attention scores, and updated hidden states. The server iteratively predicts next tokens using decoding algorithms, at each step computing a probability distribution over the vocabulary and selecting a token based on configured parameters such as temperature and top-k or top-p thresholds. The server accumulates generated token IDs until a stopping condition is met. The output is a generated token sequence representing a response sentence.

### Step 13:

The server decodes the generated token sequence into a natural language response sentence and performs post-processing.

The input is the generated token sequence from Step 12.

The server maps token IDs back to subword strings using the vocabulary, merges subwords into full words, and restores appropriate spacing and punctuation. The server may apply rule-based filters to remove incomplete fragments or repetitive patterns and to ensure inclusion of disclaimers required by policy. The output is a finalized response sentence in natural language that contains advice information related to the user's legal issue.

### Step 14:

The server evaluates legal risk and dispute complexity based on the numerical representation of the explanation information and the generated response sentence.
The input is the numerical representation from Step 6 and the response sentence from Step 13.
The server encodes the response sentence using an encoder network to obtain a response embedding, concatenates or otherwise combines the query embedding and response embedding into a composite vector, and feeds this vector into a risk and complexity assessment model. The model computes scalar scores using learned weights and activation functions, and the server compares these scores with predefined thresholds. The output is at least one legal risk score, at least one complexity score, and a decision flag indicating whether a predetermined condition is satisfied.

### Step 15:

The server determines whether to obtain expert information from a legal practitioner information storage unit and, if necessary, retrieves such information.
The input is the decision flag and scores from Step 14, and the legal field category from Step 7.
The server checks the decision flag; if the condition is satisfied, the server queries the practitioner information storage using filters derived from the legal category and optional regional or subject parameters, and selects one or more practitioner records based on matching criteria. The data processing includes database search and ranking based on attributes. The output is either an empty set if no recommendation is needed or a set of expert information entries to be appended to the advice.

### Step 16:

The server performs an emotional state estimation process on the explanation information and adjusts prompt-related instruction content or tone markers for feedback.
The input is the explanation text from Step 4 and optionally its numerical representation from Step 6.
The server encodes the explanation text with an encoder network, applies an emotion classifier to produce probabilities for different emotional states, and selects the most likely state or a combination. The server then determines text fragments or markers such as “use a calm and reassuring tone” or “provide a concise and formal explanation” and associates these markers with the response sentence as control metadata or in-text annotations. The output is an estimated emotional state label and corresponding tone or detail-level instructions that influence how the advice is presented.

### Step 17:

The server composes response information by combining the response sentence, any expert information, and tone or detail indicators derived from the emotional state.
The input is the response sentence from Step 13, the expert information from Step 15, and the tone and detail-level instructions from Step 16.
The server assembles these components into a structured response object, optionally inserting expert recommendation text and adjusting introductory or concluding phrases to match the emotional guidance. The server includes disclaimers and metadata such as timestamps and identifiers. The output is a response information object ready for transmission to the terminal.

### Step 18:

The server transmits the response information to the terminal through an encrypted communication channel.
The input is the response information object from Step 17.
The server serializes the object into a network-transmissible format, encrypts the serialized data according to the active security protocol, and sends the encrypted data via the network interface to the terminal. The output is an encrypted response message delivered to the terminal.

### Step 19:

The terminal receives, decrypts, and parses the response information, and prepares display content.
The input is the encrypted response message from Step 18.
The terminal performs decryption using session keys, parses the serialized structure to recover the response sentence, expert information, and any presentation instructions, and maps these elements to user interface components such as text areas and buttons. The output is a set of UI elements and display-ready text segments.

### Step 20:

The terminal displays the advice information and any expert recommendation to the user in accordance with tone and detail instructions.
The input is the UI elements and display-ready text segments from Step 19.
The terminal renders the response sentence on the screen, arranges sections such as main advice, additional explanations, and expert referrals, and applies formatting such as headings, paragraph breaks, or emphasis in line with the tone and detail metadata. The output is a visual presentation on the terminal's display that the user can read and interact with.

### Step 21:

The user reviews the displayed advice and optionally performs follow-up actions via the terminal.
The input is the visual presentation on the terminal screen.
The user reads the advice, interprets the suggested steps, and may choose to request further clarification, initiate contact with a recommended expert, or close the application. The user's interactions generate new inputs for the terminal, which in turn can trigger repetition of earlier steps with updated explanation information. The output is either a new user query, a connection to an external communication channel, or termination of the current consultation session.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented legal advisory systems typically rely on rule-based engines or generic text generation models that operate on unstructured user input. Such systems often treat a user's free-text description of a legal problem as a simple string, without performing robust linguistic normalization, domain-specific keyword extraction, or structured contextualization against past case data sets. As a result, the underlying computing components underutilize available processing resources, exhibit suboptimal relevance in generated advice, and require repeated network interactions or manual reformulation of queries by the user, thereby imposing increased latency and computational overhead on servers and client terminals.

In addition, traditional systems generally do not integrate a tightly coupled pipeline in which natural language processing, similarity-based retrieval of case information, and generative model prompting are coordinated within a single optimized data flow. In many existing implementations, retrieval of reference cases, construction of prompts, and generation of advice are handled as loosely connected modules, resulting in redundant data transformations, inefficient memory usage, and unnecessary serialization and deserialization of intermediate results. This fragmented architecture degrades throughput of the processor, increases response time, and limits the scalability of the system when servicing a large number of concurrent legal queries.

Further, existing systems often ignore the user's emotional state or treat it as a peripheral user-interface concern handled only at the display layer. Without incorporating emotional-state analysis into the core processing pipeline, the computing system cannot dynamically adjust the structure, granularity, and tone of generated legal advice at the model-output level. This omission leads to generic, sometimes inappropriate, responses that either overload the user with complex information or fail to provide sufficient guidance, which in turn forces additional follow-up queries, causes superfluous network traffic, and wastes processor cycles. Moreover, security and privacy measures in prior art systems are frequently implemented as add-on components rather than as integral constraints on data flows within the legal advisory pipeline. Communication data and stored advisory data are not always uniformly protected by encryption and access control at each processing stage, which creates additional complexity in managing secure data paths and can require external middleware, further complicating the system architecture and its maintenance.

Accordingly, there is a need for a computer-implemented legal advisory system and method that technically improve the functioning of the computing environment itself. In particular, there is a need for a system in which a processor: (i) performs structured natural language processing to normalize and enrich user queries; (ii) constructs optimized prompt sentences for a generative AI model based on extracted legal features and retrieved reference cases; (iii) generates legal advice information with integrated reference case summaries; (iv) dynamically adjusts the advice according to an analyzed emotional state of the user; and (v) applies encryption and access control coherently across communication and storage flows. Such a system should reduce redundant processing, improve relevance and stability of model outputs, decrease end-to-end latency, and enhance overall computational efficiency and security of legal advisory operations.

The specific processing by the specific processing unit 290 of the data processing device 12 in Application Example 1 is realized by the following means.

The present invention provides a server comprising a processor configured to learn an information set including court-related information and to configure a generative model that receives inquiry information regarding a legal problem of a user as input, to preprocess character information regarding the legal problem received from a terminal of the user by using a natural language processing component so as to perform operations including tokenizing a sequence of words, extracting important terms, and normalizing the character information, to generate a prompt sentence including the preprocessed character information and the extracted important terms and to input the prompt sentence to the generative model so as to generate legal advice information, to perform similarity calculation based on at least one of the character information regarding the legal problem and the preprocessed character information in order to acquire reference case information with high relevance from a past case information set and to add summary information of the reference case information to at least one of the prompt sentence and the legal advice information, to analyze an emotional state of the user and to adjust at least one of an expression content and a presentation format of the legal advice information according to the emotional state, to transmit the legal advice information and the summary information of the reference case information to the terminal of the user via a communication path so as to cause the terminal of the user to present the legal advice information, and to encrypt communication data and stored data including at least the inquiry information, the legal advice information, and the reference case information by using an encryption scheme and to perform access control by authentication processing. This enables an integrated and technically improved legal advisory pipeline in which the processor efficiently transforms unstructured user input into structured, context-enriched prompts for a generative model, retrieves and incorporates relevant case information in a single optimized flow, dynamically adapts generated content based on the user's emotional state, and enforces secure handling of advisory data, thereby reducing processing redundancy, lowering response latency, enhancing relevance and stability of model outputs, and improving overall performance and security of the computer system.

The term “processor” refers to a hardware or virtual computation unit, such as a central processing unit or a processing core of an information processing apparatus, that executes instructions to perform data processing operations specified by software or firmware.

The term “information set including court-related information” refers to a structured or unstructured collection of digital records, such as case texts, decisions, summaries, and metadata, that describe legal disputes, judicial outcomes, and associated legal reasoning.

The term “generative model” refers to a parameterized information processing model, such as a neural network-based generative AI model, that receives input data and produces new output data by probabilistically generating sequences of symbols or tokens based on learned patterns.

The term “inquiry information” refers to digital data representing a user's request, question, or description of circumstances regarding a legal problem, including at least character information input by the user through a terminal.

The term “legal problem” refers to a situation, dispute, or question involving the application, interpretation, or enforcement of legal rules, rights, or obligations.

The term “user” refers to a human individual or an entity that operates a terminal to submit inquiry information and to receive legal advice information from the system.

The term “terminal” refers to an electronic apparatus, such as a communication device, a computing device, or a display device, that is configured to send inquiry information to the server and to receive and present legal advice information.

The term “character information” refers to text data composed of characters encoded in a digital format, representing at least part of the user's description of a legal problem or situation.

The term “natural language processing” refers to a set of computational techniques and algorithms used to analyze, interpret, and transform human language text, including but not limited to tokenization, part-of-speech tagging, syntactic parsing, and semantic analysis.

The term “tokenizing a sequence of words” refers to a process of dividing character information into smaller units, such as words, subwords, symbols, or punctuation marks, to enable subsequent linguistic or statistical processing.

The term “important terms” refers to tokens, phrases, or concepts extracted from character information that are determined, by a weighting algorithm or rule, to be highly relevant to a legal problem or to a retrieval or generation task.

The term “normalizing the character information” refers to a process of converting character information into a standardized representation, including operations such as case conversion, removal or replacement of special symbols, and unification of character encodings.

The term “prompt sentence” refers to a text string or sequence of tokens that includes at least part of the preprocessed character information and the important terms and that is supplied as input to the generative model to control or guide the content of generated output.

The term “legal advice information” refers to generated digital text or structured data produced by the generative model that explains, suggests, or outlines potential legal considerations, options, or actions related to a legal problem, without necessarily constituting formal legal counsel.

The term “similarity calculation” refers to a computational process that determines a degree of resemblance between pieces of information, such as between a user's inquiry and stored case information, by using a metric or model, for example, a distance function on embedding vectors.

The term “past case information set” refers to a stored collection of case-related records, including at least one of full-text decisions, summaries, annotations, and associated metadata, that describe previously adjudicated legal cases.

The term “reference case information” refers to selected case-related records from the past case information set that are determined, based on similarity calculation, to be relevant to a current legal problem.

The term “summary information of the reference case information” refers to condensed textual or structured descriptions of reference case information that highlight key facts, legal issues, holdings, or principles of the referenced cases.

The term “emotional state of the user” refers to a condition or tendency of a user's affect or sentiment, such as stress, anxiety, confusion, or confidence, inferred from user input, interaction behavior, or other measurable signals.

The term “expression content of the legal advice information” refers to linguistic characteristics of the generated legal advice, including word choice, sentence structure, level of detail, and explanatory style.

The term “presentation format of the legal advice information” refers to a manner in which legal advice information is arranged or displayed to the user, including layout, segmentation into sections, and use of headings, lists, or emphasis.

The term “communication path” refers to one or more communication links or networks, such as wired networks, wireless networks, or communication protocols, that enable data transmission between the server and the terminal.

The term “litigation success possibility” refers to an estimated likelihood that a user may obtain a favorable outcome in a potential or ongoing legal proceeding, as determined by a computational evaluation or heuristic.

The term “legal professional” refers to a person having specialized legal knowledge, such as a lawyer or legal consultant, who is capable of providing formal legal services or representation.

The term “situation description” refers to narrative character information provided by the user that explains factual circumstances, events, or context relevant to a legal problem.

The term “structured information” refers to data organized according to a predefined schema or representation, such as key-value pairs, labeled entities, or classified attributes, derived from unstructured character information.

The term “candidate solution information” refers to one or more potential response options, strategies, or courses of action generated by the generative model before final selection or modification as legal advice information.

The term “encryption scheme” refers to a cryptographic method or algorithm used to convert readable data into an encrypted form that can be restored only by authorized entities having corresponding decryption capability.

The term “communication data” refers to data transmitted between the server and the terminal, including at least inquiry information, legal advice information, and reference case information.

The term “stored data” refers to data held in a memory device or storage device of the server or another component, including at least records of inquiries, generated advice, and case-related information.

The term “access control” refers to a mechanism or procedure that restricts or grants access to data or system functions based on authentication results, authorization rules, or security policies.

The term “authentication processing” refers to a procedure by which an identity of a user or a device is verified using credentials, tokens, or other identifiers before granting access to protected data or functions.

In one embodiment, a server cooperates with one or more terminals operated by a user to provide legal advice information based on a generative AI model. The server includes at least one processor, a memory device, a network interface, and a non-transitory storage device. The processor executes instructions stored in the memory device to implement a plurality of software modules, including a natural language processing module, a similarity retrieval module, a generative model inference module, an emotional state analysis module, and a security control module. The server is connected via a communication network, such as the Internet or a mobile communication network, to the terminal. The terminal includes a display device, an input device, a communication interface, and a local memory, and executes an application or a web browser that provides a user interface for transmitting inquiry information and receiving legal advice information.

The server uses general-purpose computing hardware, such as a central processing unit and a graphics processing unit. The server optionally uses a multi-core CPU architecture and one or more GPUs configured for tensor operations. The server runs an operating system such as a server OS and uses software frameworks including a web application framework, a natural language processing library such as spaCy or a similar library, a machine learning framework such as a deep learning framework, and a database system such as a relational database management system and optionally a vector search engine. The server stores an information set including court-related information in the storage device. The information set includes case texts, summaries, and metadata that are indexed by identifiers and stored in a structured data format, such as tables holding case metadata and a document store or vector index holding text and embeddings.

The server configures a generative AI model as a transformer-based neural network. The server uses an architecture where an encoder-decoder or decoder-only stack of transformer blocks is defined by multiple layers of multi-head self-attention and position-wise feedforward networks. The server stores model parameters, such as weight matrices for attention heads, feedforward layers, layer normalization parameters, and embedding matrices, in the memory device. The server trains or fine-tunes the generative AI model using the information set including court-related information. During training, the server uses a loss function such as a cross-entropy loss between predicted token sequences and ground-truth token sequences and updates the model parameters using an optimization algorithm such as stochastic gradient descent or a variant such as Adam. The server performs backpropagation through the network to compute gradients for each trainable parameter. The server optionally applies training techniques such as gradient clipping, learning rate scheduling, and data augmentation on the text data (for example, paraphrasing, reordering of non-critical clauses, or the insertion of neutral tokens) to improve robustness and generalization.

The server represents text data internally as sequences of token identifiers. The server uses a tokenizer based on subword units, such as a byte-pair encoding or unigram model, that converts sequences of characters into discrete token indices. The server assigns each token index to a vector representation by looking up an embedding matrix. The server then adds positional encodings to the token embeddings to represent sequence order. The transformer blocks compute attention weights across the token sequence and generate context-sensitive representations by matrix multiplications and non-linear activations. By implementing this architecture, the server improves the ability of the model to capture long-range dependencies and complex legal reasoning patterns across large documents as compared to traditional n-gram or rule-based engines, thereby increasing the precision and stability of generated legal advice without increasing latency beyond practical limits.

The server uses a natural language processing module to normalize and enrich user-input character information. The natural language processing module includes functions for tokenizing the text, assigning part-of-speech tags, performing named entity recognition, and extracting key phrases related to legal concepts. The server executes these functions using the CPU, optionally accelerated by vectorized instructions. The server processes the inquiry information to identify important terms, such as types of contracts, legal issues, parties, time periods, and monetary amounts. The server stores the result of this analysis as structured information, for example a data structure comprising a list of tokens, a set of important terms, a set of recognized entities, and a classification label indicating a legal domain. This structured representation enables the server to construct more precise and compact inputs to the generative AI model, thereby reducing the number of tokens required and saving computational resources in the model inference step.

The server uses a similarity retrieval module to compute similarity between the inquiry information and stored past case information. The server first converts the normalized inquiry text into an embedding vector using a sentence-level embedding model. The server uses a neural network such as a bidirectional encoder or a transformer encoder fine-tuned to map legal texts into a continuous vector space. The server stores precomputed embedding vectors of past case texts in a vector index. The server computes similarity scores by applying a metric such as cosine similarity or dot product. The server retrieves a fixed number of cases having the highest similarity scores. The server then generates summary information of the retrieved reference cases either by using stored summaries or by applying a summarization model. The server feeds this summary information into the prompt sentence or attaches it to the legal advice information. By using continuous embeddings and similarity metrics, the server performs retrieval in a high-dimensional space that captures semantic relations between legal problems and judicial decisions. This approach reduces the need for manually defined keyword rules and improves recall and precision of relevant cases, which contributes to more contextually grounded advice and reduces processing required for trial-and-error queries from the user.

The server constructs a prompt sentence that serves as input to the generative AI model. The server uses a prompt assembly component that receives the original inquiry text, the extracted important terms, the structured information, and the summary information of reference cases. The server formats these elements into a text string according to a template stored in the memory device. The server may include system-level instructions about tone and structure. For example, the server may construct a prompt sentence such as:

“You are a generative AI model specialized in legal analysis of court precedents.

User's question: ‘The non-compete clause in my employment contract seems too broad, and I am not sure if it is enforceable.’

Extracted keywords: [‘non-compete clause’, ‘employment contract’, ‘enforceability’, ‘labor law’].

Relevant precedents (summaries):
1. A case where a court limited enforcement of an overly broad non-compete clause that restricted work across an entire industry.
2. A case where a court upheld a non-compete clause that was limited in time and geographic scope.

Task: Based on your training on court decisions and legal principles, provide a structured explanation of possible legal issues, factors that courts consider when evaluating non-compete clauses, and practical options the user might consider, and include a disclaimer that this is not formal legal advice.”

In another example, the server may construct a prompt sentence such as: “Please provide legal advice regarding a breach of contract.

Consider the following user input: ‘My contract clause about early termination fees is unclear, and the other party is demanding a large penalty.’

Based on similar court precedents and general legal principles, suggest potential remedies, negotiation strategies, and risks the user should be aware of. Write the answer in clear, non-technical language and include a short disclaimer that this is not formal legal advice.”

The server directly integrates the extracted important terms and reference case summaries into the prompt sentence. This integration allows the generative AI model to receive a compact but information-rich conditioning context. Because the generative model no longer needs to infer basic entities and context solely from raw text, the model can allocate more capacity to reasoning and text generation. As a result, the server reduces the average number of decoding steps needed to reach a satisfactory answer and improves computational efficiency on the GPU.

The server uses an emotional state analysis module to analyze the emotional state of the user. The server may estimate the emotional state based on sentiment analysis applied to the inquiry information and, optionally, interaction patterns such as repeated clarifications, use of certain expressions, or temporal spacing of queries. The server uses a sentiment classifier implemented as a neural network, such as a fine-tuned transformer encoder or a recurrent network, trained on annotated emotional data. The server outputs an emotional state label or a continuous score, such as “high anxiety,” “moderate concern,” or “neutral.” The server then uses this emotional state to adjust at least one of the expression content and the presentation format of the legal advice information. For example, when the server detects a high-anxiety state, the server configures the generative AI model prompt to request shorter sentences, more explicit step-by-step guidance, and additional reassurance regarding next actions, while avoiding overly technical citations. When the emotional state is neutral or expert-like, the server may instruct the model to provide more detailed analysis and references. By incorporating emotional state as an explicit parameter into prompt construction and postprocessing, the server reduces the likelihood that the user will need multiple follow-up submissions to obtain information that is understandable at the appropriate level, thereby reducing network traffic and processing load.

The server uses a security control module to protect inquiry information, legal advice information, and reference case information. The server applies encryption to communication data and stored data by using cryptographic algorithms such as symmetric-key encryption and public-key protocols. The server terminates secure communication sessions using standardized protocols. The server encrypts stored data in the database and in backups using data-at-rest encryption techniques. The server performs authentication processing and access control by verifying user credentials or tokens before allowing access to stored records. By integrating encryption and access control into the same processing pipeline that performs natural language processing, similarity retrieval, and generative inference, the server avoids the need for separate external security gateways that may cause additional latency or data-copy operations.

The terminal presents the legal advice information to the user in a structured format. The terminal may present sections labeled “Issue,” “Legal Considerations,” “Possible Actions,” and “Disclaimer.” The terminal may highlight important terms extracted by the server and may provide interactive controls that, when operated by the user, request additional explanation or display full reference case summaries. The terminal may run on different hardware, such as a smartphone, a tablet, or a personal computer. The terminal uses its local processing capability to parse the response from the server and render the content on the display device using a user interface framework.

In an alternative embodiment, the server distributes some components, such as the natural language processing module or the emotional state analysis module, across multiple machines. The server may deploy a microservice architecture where separate services handle parsing, retrieval, generation, and security, with each service running in a containerized environment. The server may also use different natural language processing libraries or different generative models. For instance, the server may employ a smaller generative model for low-latency scenarios and a larger model for complex queries. The server can select an appropriate model based on detected complexity of the inquiry information or current system load, thereby improving overall throughput and response time.

In another embodiment, the server adjusts the retrieval strategy. The server may use hybrid retrieval combining keyword-based search and embedding-based similarity search. The server may first perform a keyword filter to narrow down candidate cases and then apply vector similarity to rank these candidates. This hybrid strategy reduces the size of the vector search space and increases retrieval speed while maintaining high relevance. The server can also maintain separate indexes for different legal domains and select the index based on domain classification of the inquiry information, further improving efficiency.

In another variation, the server modifies the architecture of the generative AI model by incorporating additional input channels for structured features. The server may attach embeddings of legal domain labels, emotional state labels, or numerical features such as estimated litigation success probability as additional tokens or as conditioning vectors added to the transformer layers. This design allows the generative model to integrate high-level features with text context during attention computation. As a result, the server can produce outputs that are not only textually coherent but also globally consistent with retrieved case statistics and user profile information, improving both relevance and consistency of advice. The server improves computing technology in multiple ways. The server uses structured pre-processing and prompt construction to reduce token length and improve model conditioning, which directly reduces the number of floating-point operations required for each inference and thereby decreases latency on GPU hardware. The server uses embedding-based similarity retrieval and domain-specific indexing to reduce search complexity and memory transfers as compared to naive full-text search. The server avoids repeated re-analysis of conversation history by caching intermediate structured representations and embeddings, thus reducing redundant natural language processing and network usage. The server integrates emotional state analysis into the model prompting pipeline, which reduces the number of follow-up interactions required for the user to obtain digestible advice. By combining these technical features, the server increases throughput, reduces error rates in retrieval and generation, and enhances the overall stability and scalability of the legal advisory system beyond what could be achieved by merely automating human drafting or consultation steps.

The server processes data based on non-traditional rules that differ from simple human heuristics. The server does not merely apply fixed legal rules but instead encodes high-dimensional relationships between inquiry information and case outcomes through learned weights in the neural network. The attention mechanisms compute context-dependent relevance scores across all positions in the input sequence, which cannot be practically replicated by rule-based or manual processes. The embedding-based retrieval uses continuous similarity in vector spaces rather than exact keyword matching, enabling the system to identify conceptually related cases even when terminology differs. These algorithmic methods are specifically adapted to the capabilities of digital processors and memory architectures, leading to technical improvements in information retrieval and text generation within a computing environment.

In all embodiments, the server, the terminal, and the user cooperate such that the user provides inquiry information through the terminal, the terminal communicates this information to the server, and the server executes the above-described technical processes on computing hardware to generate and return legal advice information that is contextually grounded, efficiently computed, and securely transmitted and stored.

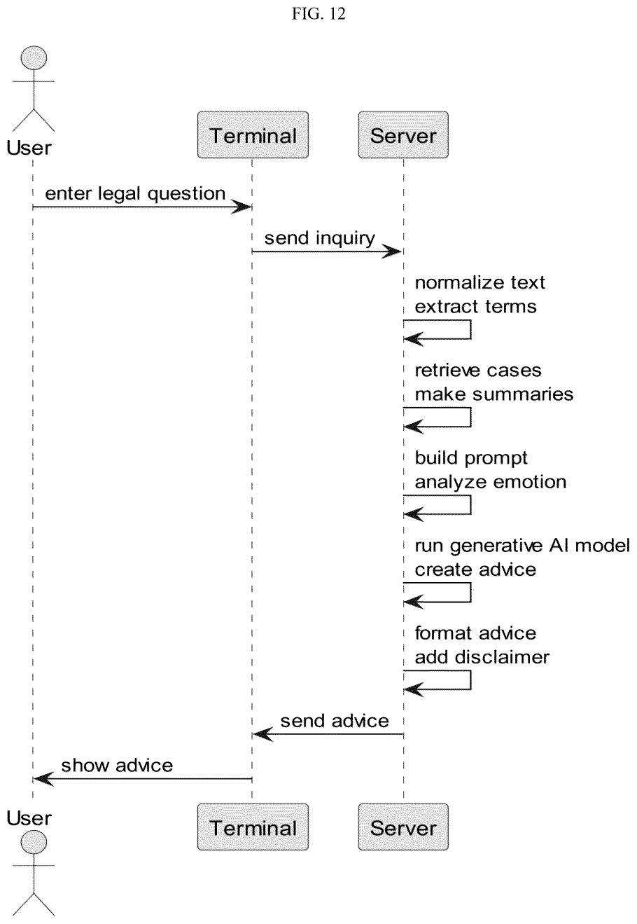

The following describes the processing flow using FIG. 12.

### Step 1:

The user operates the terminal to input inquiry information.

The user opens an application or a web page on the terminal and types a description of a legal problem into a text input field. The terminal receives the text as character information, for example: “The non-compete clause in my employment contract seems too broad, and I am not sure if it is enforceable.” The terminal sets this text as input and temporarily stores it in a local memory buffer. The terminal then performs data processing by encapsulating the text, a user identifier, and optional metadata (such as language and time) into a data structure. The terminal outputs a formatted request object that is ready to be transmitted to the server.

### Step 2:

The terminal transmits the inquiry information to the server.
The terminal takes as input the formatted request object containing the user's character information and associated metadata. The terminal performs data processing by serializing the request object into a transmission format and by establishing a secure communication session with the server. The terminal then sends the serialized request to the server via a communication interface. The output of this step is an encrypted network message containing the inquiry information that is delivered to the server.

### Step 3:

The server receives and validates the inquiry information.

The server takes as input the encrypted network message from the terminal. The server performs data processing by decrypting the message, parsing protocol headers, and extracting the serialized request object. The server further validates the request format, checks required fields such as the character information, and generates a unique request identifier. The server then stores the raw input text and metadata in a storage device for logging and later reference. The output of this step is a validated and stored representation of the inquiry information associated with a request identifier.

### Step 4:

The server normalizes the character information using a natural language processing module.
The server takes as input the raw character information associated with the request identifier.
The server performs data processing by applying text normalization operations, including trimming whitespace, standardizing newline characters, and converting special punctuation to standard forms. The server may also perform case normalization while preserving a copy of the original text. The server uses a natural language processing library to tokenize the text into a sequence of tokens and to remove or mark non-informative tokens such as excessive punctuation. The output of this step is normalized character information represented as a token sequence and associated text string stored in memory.

### Step 5:

The server analyzes the normalized character information to extract important terms and structured features.
The server takes as input the normalized token sequence and text string. The server performs data processing using a natural language processing model by assigning part-of-speech tags to tokens, detecting named entities such as contract types, monetary amounts, dates, and party names, and identifying multi-word legal phrases. The server applies a weighting algorithm to compute relevance scores for tokens and phrases and selects those with scores above a predetermined threshold as important terms. The server then organizes these important terms, identified entities, and phrases into a structured data object that also includes an inferred legal domain label. The output of this step is structured information containing tokens, important terms, entities, and domain classification.

### Step 6:

The server computes similarity between the inquiry information and past case information.
The server uses as input the normalized text of the inquiry information and the structured information, including important terms. The server generates a fixed-dimensional embedding vector by passing the normalized text through a sentence embedding model. The server then performs data processing by querying a vector index containing precomputed embeddings of past case information. The server calculates similarity scores between the inquiry embedding and each stored case embedding, using a metric such as cosine similarity or inner product. The server selects a subset of past case records with the highest similarity scores as reference case information. The output of this step is a ranked list of reference case records and their associated similarity scores.

### Step 7:

The server generates summary information of reference cases.

The server takes as input the list of selected reference case records. For each reference case, the server either retrieves a pre-stored summary from a database or generates a summary using a summarization component. When generating a summary, the server processes the full case text through a summarization model or an extraction algorithm that selects key sentences based on sentence importance scores. The server truncates or compresses the summaries to a length suitable for inclusion in a prompt sentence. The output of this step is a set of condensed summary information entries associated with the reference case records.

### Step 8:

The server constructs a prompt sentence for a generative AI model.
The server uses as input the original character information, the structured information including important terms, and the summary information of the reference cases. The server performs data processing by inserting these elements into a predefined template to form a single prompt sentence or a multi-part prompt text. The server may add control instructions regarding tone, structure, or level of detail. For example, the server may construct the following prompt sentence:
“You are a generative AI model specialized in legal analysis of court precedents.
User's question: ‘The non-compete clause in my employment contract seems too broad, and I am not sure if it is enforceable.’
Extracted keywords: [‘non-compete clause’, ‘employment contract’, ‘enforceability’, ‘labor law’].
Relevant precedents (summaries):
1. A case where a court limited enforcement of an overly broad non-compete clause that restricted work across an entire industry.
2. A case where a court upheld a non-compete clause that was limited in time and geographic scope.
Task: Based on your training on court decisions and legal principles, provide a structured explanation of possible legal issues, factors that courts consider when evaluating non-compete clauses, and practical options the user might consider, and include a disclaimer that this is not formal legal advice.”
The server outputs a finalized prompt sentence text that is ready to be supplied to the generative AI model.

### Step 9:

The server analyzes the emotional state of the user and adjusts the prompt sentence.

The server takes as input the original character information and, optionally, interaction history associated with the user. The server processes this input using an emotional state analysis model to compute an emotional state label or score. The server then performs data processing to adjust the prompt sentence by appending or modifying instructions regarding style, length, and level of detail according to the emotional state. For example, when the emotional state indicates high anxiety, the server inserts instructions to produce shorter, clearer explanations and explicit step-by-step guidance. The output of this step is an emotion-adjusted prompt sentence that encodes instructions tailored to the user's inferred emotional state.

### Step 10:

The server executes inference of the generative AI model based on the prompt sentence.
The server takes as input the emotion-adjusted prompt sentence. The server processes the prompt sentence by tokenizing it into a sequence of token identifiers using a model-specific tokenizer. The server then loads the corresponding token embeddings and applies the transformer-based generative AI model. The server performs matrix multiplications, attention computations, and non-linear transformations layer by layer to obtain probability distributions over next tokens. The server selects output tokens according to a decoding algorithm, such as greedy search or beam search, until a stopping condition is met. The server decodes the output token sequence back into character information. The output of this step is raw legal advice information in text form, generated based on the prompt sentence.

### Step 11:

The server post-processes the generated legal advice information.

The server takes as input the raw generated advice text. The server performs data processing by scanning for prohibited or undesired content based on predefined rules, removing or modifying inappropriate phrases, and ensuring that a disclaimer is present. The server also formats the advice into a structured layout, dividing it into sections such as “Issue,” “Legal Considerations,” “Possible Actions,” and “Disclaimer,” and may insert bullet points or numbered lists. If the system requires, the server appends the summary information of the reference cases to the advice text in a clearly separated section. The output of this step is a cleaned and structured legal advice information text ready for transmission to the terminal.

### Step 12:

The server prepares and encrypts a response message.
The server uses as input the structured legal advice information and the associated reference case summaries. The server constructs a response object containing these items and the request identifier. The server serializes the response object into a transmission format and applies encryption using a selected encryption scheme. The server sets appropriate response headers and status information and passes the encrypted payload to the network interface. The output of this step is an encrypted response message containing the legal advice information destined for the terminal.

### Step 13:

The terminal receives, decrypts, and parses the response message.
The terminal takes as input the encrypted response message from the server. The terminal performs data processing by decrypting the payload using keys or session information maintained for the secure communication channel. The terminal parses the decoded data to extract the structured legal advice information and reference case summaries. The terminal verifies message integrity and associates the response with the originating user request. The output of this step is a local data structure on the terminal containing the sections of legal advice and related information.

### Step 14:

The terminal displays the legal advice information to the user.
The terminal uses as input the local data structure containing the sections of legal advice and reference case summaries. The terminal performs data processing by mapping each section to corresponding user interface elements, such as headings, text blocks, and interactive areas.
The terminal renders the advice text on the display, highlights important terms, and optionally provides user interface controls that allow the user to expand reference case summaries or request further clarification. The output of this step is a visual and interactive presentation of the legal advice information on the terminal's display that the user can read and interact with.

### Step 15:

The user reviews the legal advice information and optionally provides follow-up input.

The user views the information presented on the terminal display. Based on the content, the user may decide to ask a follow-up question or request more detail about a specific aspect. The user then operates the input device of the terminal to enter additional character information, such as “What if the non-compete clause covers the entire country for three years?” The terminal receives this new input as data and associates it with the previous interaction context. The output of this step is updated inquiry information that the terminal can again encapsulate and transmit to the server, causing repetition of the above steps for a new or refined round of processing.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented legal support systems typically focus on presenting static reference information, simple rule-based checklists, or keyword-based retrieval of legal documents. Such systems generally do not transform user-provided case descriptions into a machine-optimized representation that can be effectively consumed by a generative AI model, and therefore cannot reliably produce a quantitatively interpretable prediction, such as a winning probability for a legal case. In addition, existing systems often treat generative AI models as generic text generators without controlling input prompts and output post-processing in a manner that is integrated with downstream computational modules, such as threshold-based decision engines and expert recommendation engines. As a result, there are several technical problems in the operation of computing devices in this field. First, a processor is not systematically configured to convert heterogeneous user inputs, including case outlines, party information, evidence information, and situation descriptions, into structured data and token sequences optimized for a generative AI model. This leads to inefficient utilization of processing resources, unstable inference behavior, and difficulty in reproducing consistent prediction outputs. Second, a processor is not configured to tightly couple the generative AI model's textual output with numeric evaluation logic, such that a winning possibility can be automatically extracted, normalized, and compared with a predetermined reference value in a deterministic manner. Third, a processor is not configured to automatically route cases to an appropriate expert recommendation workflow based on the machine-extracted winning possibility, which prevents the computing system from efficiently orchestrating multi-stage processing that includes inference, evaluation, and expert selection.

Moreover, typical systems do not provide a mechanism to embed structured legal case attributes, such as a type of legal issue, a type of judicial procedure, and factual circumstances, directly into a prompt sentence used for the generative AI model, while simultaneously supplying the structured data as a separate input. This lack of coordinated prompt construction and dual-channel input (natural language plus structured data) reduces the accuracy, interpretability, and computational efficiency of the model's evaluation output. Furthermore, many implementations do not systematically define how the output of a generative AI model is transformed into standardized output information, displayable on a communication terminal, that includes both the predicted winning possibility and recommendation information regarding legal professionals.

Accordingly, there is a need for an improved computer-implemented system in which a processor is specifically configured to (i) preprocess legal case information into a representation optimized for a generative AI model, (ii) generate and supply a controlled prompt sentence together with structured data to the generative AI model, (iii) programmatically extract and evaluate a winning possibility from the model's textual output, and (iv) automatically drive subsequent expert recommendation and user notification processes based on that evaluated winning possibility. By configuring the processor in this way, the computing system can improve the technical functioning of the legal support platform, provide more reliable and reproducible AI-based evaluations, and more efficiently use computational resources.

The specific processing by the specific processing unit 290 of the data processing device 12 in Example 2 is realized by the following means.

The present invention provides a server comprising a processor configured to learn an information set including multiple legal case records and generate, based on text information including information on a legal issue of a user entity and explanation information derived from the text information, a prompt sentence for a generative AI model, process information acquired from the user entity via a communication terminal by performing structuring, format conversion, preprocessing, and conversion into a token sequence so that the information is converted into a format suitable for processing by the generative AI model, input the prompt sentence and the token sequence into the generative AI model to obtain text output including an evaluation value indicating a winning possibility with respect to the legal issue and explanation information relating to the evaluation value, extract numerical information indicating the winning possibility from the text output, compare the numerical information with a predetermined reference value to determine whether the winning possibility is equal to or greater than the reference value, search, when the winning possibility is determined to be equal to or greater than the reference value, for a legal professional suitable for the legal issue from a professional information set including field information, region information, and evaluation information, generate recommendation information for recommending the legal professional to the user entity, and generate output information, which is displayable on the communication terminal, including input information acquired from the user entity, the evaluation value, the explanation information, and the recommendation information relating to the legal professional, and transmit the output information to the communication terminal via a communication path. This enables the computing system to transform raw user case data into a model-optimized representation, control the behavior of a generative AI model through structured prompt construction, automatically derive and evaluate a quantitative winning possibility from the model's output, and orchestrate subsequent expert recommendation and user notification workflows in a deterministic and resource-efficient manner, thereby improving the overall technical performance and reliability of AI-assisted legal decision support.

The term “information set” refers to a collection of data elements stored in one or more storage media, the data elements including multiple records or entries that can be accessed, processed, and analyzed by a processor for a predetermined purpose.

The term “legal case record” refers to a data entry representing information relating to a legal dispute or proceeding, the information including at least one of factual circumstances, legal issues, procedural history, and outcome information.

The term “user entity” refers to a human user or an organizational user that interacts with the system via a communication terminal to provide input information relating to a legal issue and to receive output information from the system.

The term “legal issue” refers to a problem, dispute, or question that is governed by legal rules or regulations and that may be subject to resolution by a legal process or legal expert.

The term “text information” refers to information represented as character data in a natural language, including at least one of case descriptions, situation narratives, evidence summaries, and explanatory comments.

The term “explanation information” refers to information that describes or clarifies how an evaluation value, prediction, or conclusion has been derived, including reasons, contributing factors, or legal considerations.

The term “generative AI model” refers to a machine-learned computational model configured to generate output information, such as text, in response to input information, the model being trained on one or more datasets and implemented using numerical operations on digital hardware.

The term “prompt sentence” refers to a sequence of words or symbols in a natural language that is provided as input to a generative AI model to condition or control behavior of the model in generating output information.

The term “communication terminal” refers to an electronic device equipped with at least one processor, a memory, a display, and a communication interface, the device being configured to exchange data with a server over a communication network and to present information to a user entity.

The term “case outline information” refers to information that summarizes a legal case, including at least one of a case type, a date, a location, and a short description of relevant events.

The term “related party information” refers to information identifying or characterizing persons or entities involved in a legal case, including roles, relationships, or other attributes of the persons or entities.

The term “evidence information” refers to information describing materials or data that support or refute factual assertions in a legal case, including documents, witness statements, images, or other evidentiary items.

The term “situation description information” refers to narrative information provided by a user entity describing circumstances or events related to a legal issue in natural language.

The term “structuring” refers to processing in which unstructured or semi-structured data is transformed into a structured representation having predefined fields, attributes, or relationships, enabling systematic access and processing by a processor.

The term “format conversion” refers to processing that changes a representation format of data from a first format to a second format, such as from free text to a structured data format or from one serialization format to another.

The term “preprocessing” refers to processing applied to raw data before core model inference, the processing including at least one of cleaning, normalization, segmentation, and removal or masking of predetermined types of information.

The term “token sequence” refers to an ordered list of discrete units, called tokens, obtained by applying a tokenization process to text or structured data, the token sequence being suitable for input to a machine-learned model.

The term “evaluation value” refers to a numerical or symbolic value generated by a computational process, indicating a degree, likelihood, or score relating to a specified property of a legal issue or case.

The term “winning possibility” refers to a probability or likelihood that a party associated with a legal issue will obtain a favorable outcome in a legal proceeding, expressed as a numerical value or a percentage.

The term “numerical information” refers to information represented as one or more numerals, optionally including a sign, decimal point, or percentage symbol, and capable of being interpreted as a quantity by a processor.

The term “reference value” refers to a predetermined threshold value stored in a memory and used as a criterion for comparing with another value in order to make a determination or branch processing.

The term “professional information set” refers to a collection of data entries each representing information about a professional individual or organization, including attributes such as specialization, region, and evaluation.

The term “field information” refers to information indicating a professional or technical domain associated with a legal professional, such as a practice area, category of legal service, or subject matter specialization.

The term “region information” refers to information indicating a geographical or jurisdictional area in which a legal professional is authorized or accustomed to provide services.

The term “evaluation information” refers to information indicating quality, performance, reliability, or reputation of a legal professional, such as ratings, scores, or categorized assessments.

The term “legal professional” refers to a person having expertise in law, including at least one of a licensed attorney, legal advisor, or legal consultant, who is capable of providing legal services or advice.

The term “recommendation information” refers to information generated by a processor that identifies one or more legal professionals and presents them as suitable candidates for handling a legal issue of a user entity.

The term “output information” refers to information generated by a processor for presentation to a user entity via a communication terminal, including at least one of evaluation values, explanation information, and recommendation information.

The term “communication path” refers to a logical or physical channel enabling data transfer between computing devices, including at least one of wired connections, wireless connections, and routed network connections.

The term “structured data” refers to data organized according to a predefined schema with explicit fields or attributes, enabling parsing, querying, and processing by a processor in a deterministic manner.

The term “type of judicial procedure” refers to information indicating a category of legal process associated with a case, such as civil, criminal, administrative, or alternative dispute resolution procedure.

The term “factual circumstances of a case” refers to information describing events, actions, conditions, and relationships that form the factual background of a legal issue or dispute.

The term “natural language text” refers to text composed in a human language, such as sentences, phrases, or paragraphs, that can be read and understood by human users and processed by natural language processing components.

The term “instruction sentence” refers to a sentence in natural language text that directs a generative AI model to perform a specified task, such as generating an evaluation value or explanation under defined constraints.

The term “in parallel” refers to a manner of processing in which two or more inputs, such as a prompt sentence and structured data, are provided to a model or processing pipeline such that they are considered jointly in at least part of the computation.

The term “percentage” refers to a value expressing a proportion in units of one hundred, typically represented as a number between 0 and 100, optionally accompanied by a percentage symbol.

The term “information protection processing” refers to processing that enhances confidentiality, integrity, or authenticity of information during storage or transmission, including at least one of encryption, decryption, access control, and integrity verification.

The term “encryption processing” refers to processing that transforms plaintext data into ciphertext using a cryptographic algorithm and a key, such that the ciphertext is unintelligible without appropriate decryption information.

The term “server” refers to a computing apparatus including at least one processor, a memory, and a communication interface, the apparatus being configured to provide computational services or data services to one or more communication terminals over a network.

The term “processor” refers to one or more hardware processing units, such as a central processing unit or accelerator, configured to execute instructions and perform numerical or logical operations on data.

In one embodiment, a server implements the claimed system by executing a program on a general-purpose computing platform. The server includes at least one central processing unit, a main memory, a non-volatile storage device such as a solid-state drive, and a network interface controller. The server executes an operating system such as a UNIX-like operating system and application software implemented for example in a high-level programming language such as Python. The server further executes a machine learning framework such as a numerical computation library and a neural network library, and a database management system such as a relational database engine. A terminal, such as a smartphone, a tablet, or a personal computer, communicates with the server via a packet-switched communication network using a protocol such as HTTPS. A user operates the terminal to provide input information and to receive output information.

The server loads into memory a generative AI model implemented as a neural network, for example a Transformer-based sequence-to-sequence model, that has been trained using a corpus of legal case records. The server uses a machine learning framework such as a tensor computation library (for example, a library equivalent to TensorFlow) to represent the model as a computation graph comprising embedding layers, multi-head self-attention layers, feed-forward layers, normalization layers, and output projection layers. The server stores trained model parameters, including weight matrices and bias vectors for each layer, in a model file on the storage device and loads these parameters into the main memory at runtime.

The server prepares a training dataset in advance by extracting legal case records from one or more repositories into structured data tables in the database management system. Each record includes, as examples, fields for case type, jurisdiction, factual circumstances, legal issues, and outcome information such as whether a plaintiff's claim was accepted. The server converts each record into a pair of input text and output text. The input text may include a normalized case description and metadata, and the output text may include a label representing a winning possibility and an explanation. The server performs tokenization using a tokenizer such as a subword-based tokenizer, generating token sequences for both input and output texts. The server represents token sequences as integer vectors and uses them as training data for the neural network.

During training, the server executes the generative AI model on a graphics processing unit or a central processing unit using the machine learning framework. The server computes a loss function, for example a cross-entropy loss between predicted token distributions and ground-truth tokens. The server updates model parameters by applying an optimization algorithm such as stochastic gradient descent with momentum or an adaptive gradient method, using backpropagation through the layers of the network. The server optionally performs data augmentation by rephrasing legal descriptions, randomly masking tokens, or shuffling non-critical clauses in the text to improve generalization. The server continues training until a validation metric, such as accuracy or calibration of winning probabilities on a held-out set, reaches a target value.

At inference time, the server receives from the terminal user-provided information about a legal issue. The server stores this raw information into the database management system as records associated with a user identifier. The server performs preprocessing on the raw information, including normalization of character encoding, removal of markup, segmentation into sentences, anonymization of personally identifiable information by pattern matching and replacement, and mapping of categorical attributes such as case type into standardized codes. The server then performs structuring of the data into a data object that includes at least a legal issue type, a judicial procedure type, and a detailed narrative of factual circumstances.

The server converts the structured data into a format optimized for the generative AI model. The server concatenates the narrative fields and selected metadata into a single text sequence, and the server constructs a prompt sentence that contains explicit model instructions in natural language. For example, the server generates a prompt sentence such as:

“You are an AI legal assistant trained on judicial precedents. Read the following legal case details and estimate the probability that the plaintiff will win in court. First output only one percentage number between 0 and 100, and then provide a brief explanation of the main legal factors. Case details: [detailed description of the case]”
or

“Based on past traffic accident precedents in civil courts, analyze the following case and predict the winning probability for the plaintiff. Output the winning probability as a percentage and then give a concise explanation. Case details: [detailed description of the traffic accident]”

The server tokenizes the prompt sentence using the tokenizer associated with the generative AI model, generating a token sequence. In some embodiments, the server also encodes structured attributes such as the case type and judicial procedure type into additional token sequences or feature vectors that are fed into the model as separate inputs. For example, the server may map “traffic accident” and “civil” into discrete identifiers and then into embedding vectors in an auxiliary input branch of the neural network. This dual-channel input, comprising natural language tokens and structured feature vectors, enables the model to exploit both free text and structured metadata, thereby improving prediction stability and computational efficiency.

The server then executes the generative AI model with the token sequence and any structured features as input. The server performs batched matrix multiplications and non-linear transformations on the processor and, when available, on an accelerator such as a graphics processing unit, using optimized linear algebra libraries. The server generates a sequence of output token distributions step by step according to an auto-regressive decoding process, optionally using beam search or sampling with temperature adjustment. The server decodes the predicted tokens to obtain an output text that begins with a numerical percentage and continues with a natural language explanation.

The server parses the output text to extract the numerical percentage. The server applies deterministic parsing rules, for example scanning the beginning of the output for the first occurrence of a sequence of digits followed by an optional decimal separator and an optional percentage sign. The server converts this substring into a numeric value and, if necessary, normalizes the value into a 0 to 1 floating-point representation. The server thereby obtains an evaluation value representing the winning possibility for the user's legal issue. The server preserves the remainder of the output text as explanation information that describes legal factors and reasoning patterns captured by the generative AI model.

The server compares the evaluation value with a predetermined reference value stored in configuration storage or in a database table. The server performs a numerical comparison using arithmetic operations on the processor and determines whether the evaluation value is greater than or equal to the reference value. The server records the evaluation value, the comparison result, and the explanation information in the database in association with the corresponding user case record. By storing both raw AI output and standardized numeric fields, the server enables subsequent statistical analysis, calibration checks, and auditing. When the evaluation value exceeds the reference value, the server executes a professional selection module. The server retrieves professional information entries from the professional information set stored in the database. Each entry includes field information indicating areas of legal expertise, region information indicating geographical or jurisdictional coverage, and evaluation information indicating quality metrics such as aggregated ratings. The server executes query logic that filters and ranks entries based on compatibility with the user's legal issue type, jurisdiction, and possibly user preferences. The server uses deterministic ranking criteria or a further learned scoring function to select a subset of legal professionals. The server then generates recommendation information describing the selected professionals, including names, practice areas, and contact information.

The server generates output information for the terminal by constructing a response structure containing at least the evaluation value, the explanation information, and the recommendation information when applicable. The server formats this structure as data for transmission over the network and transmits it via the communication interface to the terminal. The terminal receives the output information and displays it on a screen, for example as a winning probability percentage, a textual explanation, and a list of recommended legal professionals. The user can then review this information and decide subsequent actions.

In order to improve data security during transmission, the server performs information protection processing such as encryption. The server uses a cryptographic protocol such as Transport Layer Security to encrypt payloads containing user input information and AI output information. The server maintains keys and certificates and executes cryptographic algorithms to ensure confidentiality and integrity. The terminal cooperates with the server by performing corresponding decryption and verification operations. This configuration reduces risks of interception or tampering of legal case data.

This configuration of the server improves computer technology beyond mere automation of human reasoning. By converting heterogeneous case data into structured representations and token sequences tailored to the architecture of the generative AI model, the server reduces the dimensionality and noise of input data and increases cache locality for sequence processing, which results in faster inference and lower memory usage. The explicit construction of prompt sentences with embedded structural cues and type indicators guides the attention mechanism of the Transformer layers toward legally significant portions of the input, which improves convergence behavior and prediction stability compared to naive free-text prompting.

Furthermore, the server separates AI text generation from deterministic numeric extraction and threshold-based decision logic. This modularity allows the server to parallelize model inference and post-processing, to pipeline multiple requests efficiently, and to perform caching of intermediate representations. As a result, the system can process a larger number of legal cases per unit time with reduced latency. The systematic extraction and normalization of winning probabilities also reduce variance and errors associated with purely textual advice, leading to more reproducible and machine-actionable evaluation values.

The generative AI model operates under learned internal rules that differ from human manual reasoning or simple rule-based expert systems. Through training on large numbers of legal case records, the model encodes high-dimensional correlations among textual patterns, factual structures, and outcomes in its weight matrices. The model aggregates information across sentences using self-attention and learns to prioritize certain fact patterns, such as clear violations of duty or consistent witness statements, in a manner that is difficult to capture with hand-written rules. Because the server couples this internal representation with explicit structured attributes, the model can distinguish nuance among similar narrative descriptions but different jurisdiction types or procedural postures, thereby increasing accuracy and reducing misclassification.

The server also improves data management. By storing both raw prompts, structured representations, and normalized outputs, the server can perform offline calibration analysis and adjust reference values dynamically, which allows continual improvement of the decision pipeline without retraining the entire model. The server can log intermediate attention weights or feature activations for selected cases, enabling debugging and explainability tools that are executed on the server. These tools allow system administrators to detect drifts or anomalies in model behavior and to update training datasets accordingly, leading to sustained reliability over time.

In alternative embodiments, the server can employ different neural network architectures, such as encoder-only architectures for classification with a separate regression head that directly outputs a numeric winning possibility, or encoder-decoder architectures with constrained output formats in which the first token sequence is dedicated to the numeric score. The server may replace or augment the Transformer architecture with recurrent networks or convolutional layers for domain-specific adaptations. The server can also implement different loss functions, such as a combination of cross-entropy for text tokens and mean squared error for numeric probabilities, in a multi-task learning configuration to improve calibration of probability outputs.

In further embodiments, the server can vary the method of embedding structured data. For example, the server can map categorical attributes into learned embeddings concatenated to token embeddings at each time step, or the server can feed structured features into a separate encoder whose output is fused with the text encoder through cross-attention layers. These configurations can further improve the ability of the model to use explicit metadata, thereby increasing accuracy and reducing the number of tokens required to achieve a desired performance level. As a result, inference becomes faster and bandwidth requirements are reduced because the server can transmit shorter prompts to the model.

In yet another embodiment, the server can execute multiple generative AI models specialized for different legal domains. The server can select an appropriate model based on the structured attributes of the case, such as distinguishing between traffic accidents, employment disputes, and contract litigation. This model selection can be implemented as a lightweight classifier running on the server, using features extracted during preprocessing. By directing each case to a domain-specific model with architecture and hyperparameters tuned for that domain, the server further improves prediction accuracy and reduces computation time per case.

Across these embodiments, the server, the terminal, and the user cooperate in a manner that is centered on concrete technical processing within the server. The server performs specific data transformations, numerical computations, and model executions that are defined at the level of data structures, network architectures, and numerical criteria, rather than mere high-level business logic. This design yields technical effects such as faster inference, better calibrated probability estimates, lower communication overhead, and improved reliability of automated legal evaluation and expert recommendation.

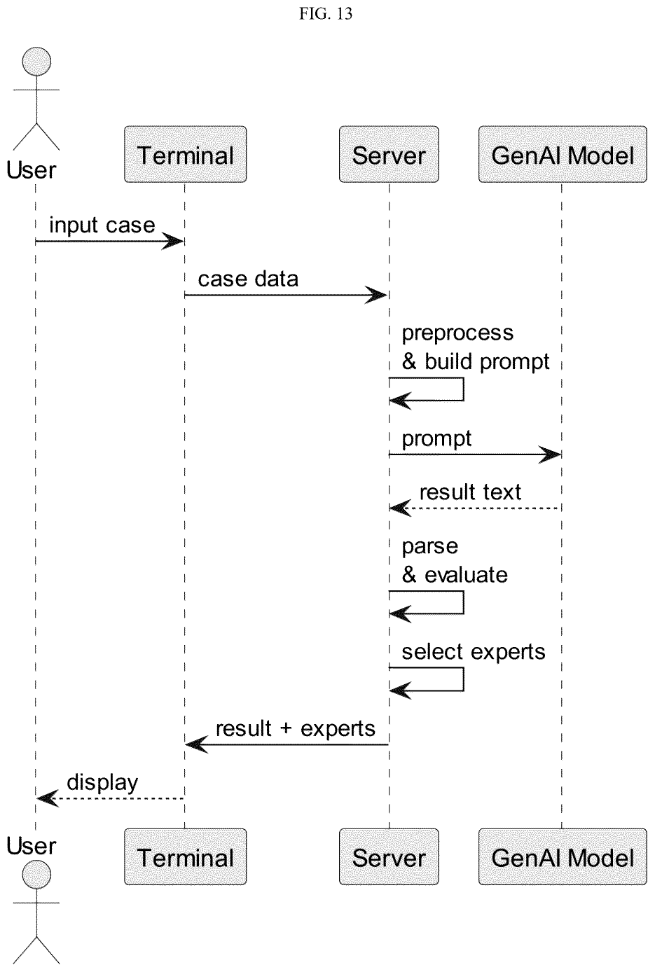

The following describes the processing flow using FIG. 13.

### Step 1:

User operates the terminal to access the system and to input legal case information.
User enters, as input, a set of fields including at least a case type, a judicial procedure type, a factual description in natural language, related party information, and evidence information into input forms displayed on the terminal.
Terminal validates the input locally, for example by checking mandatory fields and date formats, and packages the validated information into a structured data object, such as a JSON document.
Terminal outputs the structured data object and transmits it to the server over a secure communication channel.

### Step 2:

Server receives, as input, the structured data object from the terminal via the network interface.
Server parses the structured data object using a data parsing module, and maps each field (for example, case type, jurisdiction, and factual description) to corresponding attributes in an internal data structure.
Server performs data cleaning, including normalization of character encoding, removal of markup, trimming of whitespace, and replacement or masking of personally identifiable information detected via pattern matching.
Server outputs a normalized and sanitized case data structure and stores it in a database together with a generated case identifier.

### Step 3:

Server retrieves, as input, the normalized case data structure associated with the case identifier from the database.
Server performs structuring by reorganizing the fields into a canonical schema that includes at least a legal issue type, a judicial procedure type, a factual narrative, and optional evidence summaries.
Server performs format conversion by converting the canonical schema into an internal representation suitable for text generation, for example concatenating narrative fields into one continuous text block while preserving metadata tags.
Server outputs a canonical case representation that serves as the basis for prompt construction.

### Step 4:

Server receives, as input, the canonical case representation containing both narrative text and structured attributes.
Server generates a prompt sentence in natural language by embedding the canonical case representation into a predefined instruction template.
Server, for example, constructs a prompt sentence such as: “You are an AI legal assistant trained on judicial precedents. Read the following legal case details and estimate the probability that the plaintiff will win in court. First output only one percentage number between 0 and 100, and then provide a brief explanation of the main legal factors. Case details: [detailed description of the case].”
Server replaces the placeholder with the actual case description and metadata to produce a complete prompt sentence.
Server outputs the complete prompt sentence as a text string.

### Step 5:

Server receives, as input, the complete prompt sentence and the structured attributes (for example, legal issue type and judicial procedure type) from the previous step.
Server invokes a tokenizer associated with the generative AI model to convert the prompt sentence into a sequence of tokens and then into a sequence of token identifiers.
Server optionally converts the structured attributes into additional feature vectors or categorical embeddings by mapping attribute codes to indices and then to embedding vectors.
Server outputs a token sequence representing the prompt sentence and, optionally, an auxiliary feature representation for structured data.

### Step 6:

Server receives, as input, the token sequence and any auxiliary feature representation.
Server loads the generative AI model, implemented as a neural network such as a Transformer model, into memory using a machine learning framework.
Server feeds the token sequence into the model's input layer, and, if present, feeds the auxiliary feature representation into a separate input branch or concatenates it with token embeddings.
Server performs numerical computations, including matrix multiplications, non-linear activations, and attention operations across tokens, to propagate activations through the layers of the network.
Server executes an auto-regressive decoding process to generate output token distributions step by step, until a termination condition such as an end-of-sequence token is produced.
Server outputs a sequence of output token identifiers representing the generated text.

### Step 7:

Server receives, as input, the sequence of output token identifiers from the generative AI model.
Server decodes the token identifiers into characters and words using the tokenizer's decoding function, thereby obtaining an output text string.
Server parses the beginning portion of the output text using string processing and pattern matching to locate a sequence of digits optionally followed by a decimal point and a percentage symbol.
Server converts the located substring into a numerical value, for example a floating-point representation of a percentage, and normalizes it if necessary to a 0-1 scale.
Server separates the remaining part of the output text as explanation information.
Server outputs an evaluation value indicating winning possibility and corresponding explanation information.

### Step 8:

Server receives, as input, the evaluation value and explanation information.
Server retrieves a predetermined reference value from configuration storage or a database, for example a threshold percentage indicating a minimum acceptable winning possibility.
Server compares the evaluation value with the reference value by executing arithmetic and comparison operations on the processor.
Server determines whether the evaluation value is greater than or equal to the reference value and generates a decision flag indicating a high or low winning possibility.
Server outputs the decision flag along with the evaluation value and explanation information.

### Step 9:

Server receives, as input, the decision flag, evaluation value, and structured attributes such as legal issue type and jurisdiction.
Server, when the decision flag indicates that the winning possibility is equal to or greater than the reference value, queries a professional information set stored in the database for legal professionals whose field information and region information match the structured attributes of the case.
Server filters candidate professional records using selection criteria, such as matching practice area, jurisdiction, and a minimum evaluation score, by executing database queries.
Server ranks the filtered professionals according to evaluation information or predefined ranking rules and selects a subset as recommended professionals.
Server outputs recommendation information describing the selected legal professionals, including at least names, expertise areas, and contact details; if the decision flag is negative, the server outputs an indication that no recommendation is made.

### Step 10:

Server receives, as input, the evaluation value, explanation information, and recommendation information or a no-recommendation indicator.
Server constructs an output data structure containing the case identifier, the winning probability, the explanation text, and, when available, the list of recommended legal professionals.
Server converts this data structure into a response format suitable for transmission to the terminal, such as a structured message, and may include display hints such as labels for different sections.
Server outputs the response message and transmits it over the encrypted communication path to the terminal.

### Step 11:

Terminal receives, as input, the response message from the server via the network interface.
Terminal parses the response message into individual fields, such as the winning probability, the explanation text, and the recommended professionals list.
Terminal updates a user interface view to display the numerical winning probability, for example as a percentage label and graphical indicator, and to show the explanation text in a readable area.
Terminal displays, when present, the list of recommended legal professionals with their attributes and interaction elements such as buttons for initiating a call or composing an email.
Terminal outputs the rendered screen to the display device so that the user can visually review the evaluation and the recommendations.

### Step 12:

User receives, as input, the information presented on the terminal display, including the winning probability, explanation, and recommended professionals.
User interprets the displayed data and, based on the evaluation and explanation, decides whether to contact a recommended professional or to provide additional case information.
User, when wishing to refine the analysis, may input further details or corrections through the terminal, thereby generating new input information that can be transmitted to the server and processed again according to the preceding steps.
User outputs, by interacting with the terminal, control commands such as selecting a professional, requesting another evaluation, or terminating the session.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented legal support systems primarily treat user input as static textual data and generate rule-based responses or simple template-based outputs. Such systems suffer from several technical shortcomings.
First, existing systems do not dynamically construct input instructions (prompt sentences) for a generative AI model based on a structured representation of a user's case. Raw free-form text is typically passed directly to a model or a fixed template is used, which leads to suboptimal utilization of machine resources, unstable output quality, and inefficiencies in the way textual data is processed and transformed inside the system. The computing resources of the server are not effectively directed to the salient legal features of each case, resulting in unnecessary processing and network overhead.
Second, conventional systems do not systematically analyze a user's emotional state at the machine level and do not integrate an emotion profile into the computational pipeline that prepares and adjusts the generative AI input and output. As a result, server-side processes treat all inputs uniformly. This causes several technical issues: processing flows cannot be adaptively tuned for different categories of emotional state; message routing and expert-ranking algorithms do not consider emotion-dependent parameters; and the generative AI model is not steered, via structured prompts, to generate outputs that are optimized for the detected emotional context. Consequently, the user interface cannot be stably controlled to present information in a way that reduces repeated requests, clarifications, or premature disconnections, leading to increased server load and bandwidth consumption.
Third, existing systems rarely integrate a learned victory-likelihood prediction model and an expert recommendation model into a unified, structured case representation pipeline. Often, victory-rate estimation, if present, is performed in isolation from expert recommendation, and both are loosely coupled to the natural language understanding stage. This architectural fragmentation causes redundant computations, inconsistent usage of features, and inefficient database access, thereby increasing latency and reducing throughput. It also prevents the server from optimally scheduling processing resources across models, such as prioritizing only cases whose predicted outcome justifies execution of more expensive recommendation routines.
Fourth, in many implementations, encrypted communication and payment processing for online consultations are treated as separate subsystems that are not coordinated with the automated advice-generation pipeline. This leads to discontinuities between the stages of advice generation, expert referral, and online session establishment. The server often has to re-acquire or re-process data to bridge these subsystems, wasting CPU cycles, memory, and network transactions, and increasing the probability of inconsistent state across services. Accordingly, there is a need for improved computer-implemented techniques that: (i) convert heterogeneous user legal information into a unified structured case representation; (ii) dynamically generate and adjust prompt sentences for a generative AI model based on both the structured case representation and a quantified emotional state; (iii) jointly use the structured case representation to compute a victory likelihood and to statistically rank domain experts; and (iv) securely integrate these processes with encrypted communication and payment flows. By addressing these deficiencies, the invention aims to improve the technical functioning of the server-side legal support system, reducing redundant processing, stabilizing generative model behavior, and enhancing the efficiency and reliability of the overall computer system.

The specific processing by the specific processing unit 290 of the data processing device 12 in Application Example 2 is realized by the following means.

The present invention provides a server comprising a processor configured to generate, from user-provided legal issue information, transaction information, contract provisions, and user attribute information, a structured case representation by performing natural language preprocessing and feature extraction, to generate a prompt sentence for input to a generative AI model by combining the structured case representation, an emotion state derived from emotion analysis performed on user linguistic data, and instruction information regarding output format, to transmit the prompt sentence to the generative AI model and receive advice information including stepwise action guidelines and risk information, to execute a prediction process that numericalizes a likelihood of a favorable judicial outcome based on the structured case representation, to compute, by a statistical model trained on past consultation cases and outcomes, suitability degrees for multiple domain experts and select domain experts based on suitability degrees weighted in accordance with the likelihood of a favorable judicial outcome and the emotion state to generate referral information with an adjusted presentation order, and to protect legal issue information and settlement information by using an encrypted communication scheme when transmitting and receiving the information to and from a user terminal, while executing payment processing related to an online consultation with a selected domain expert and providing connection information for the online consultation. This enables integration of emotion-aware prompt sentence generation, victory-likelihood prediction, and expert recommendation into a unified, server-side computational pipeline that reduces redundant processing, stabilizes generative AI behavior, improves resource allocation and latency in providing legal support, and securely transitions from automated advice to online expert consultation within a single computer-implemented framework.

The term “information set including judicial decision information” refers to a collection of machine-readable data that includes records of past judicial decisions and optionally related metadata, such as case descriptions, outcomes, legal issues, and procedural information, which is used as training or reference data for one or more computational models.

The term “generative AI model” refers to a computational model implemented on a data processing apparatus and configured to generate output data, including natural language text, in response to input data such as a prompt sentence, the model being trained using machine learning techniques on large-scale datasets.

The term “prompt sentence” refers to an input sequence of symbols, including natural language text and optionally structured instructions, provided to a generative AI model to condition and control the behavior of the model and to specify the content, style, or structure of the model's output.

The term “linguistic information” refers to information expressed in human language, including but not limited to text data and speech data converted into text, that is acquired from a user and processed by the system.

The term “emotional state” refers to a representation, in categorical or numerical form, of affective characteristics inferred from user-provided linguistic information, such as levels of anger, anxiety, confidence, or calmness, which is usable by computational processes.

The term “legal issue of a user” refers to a situation, dispute, question, or concern relating to laws, regulations, or contractual obligations that is described or indicated by the user and for which the user seeks guidance.

The term “advice content” refers to information generated by a generative AI model or other computational process that proposes actions, explains possible outcomes, or identifies risks in relation to the legal issue of a user.

The term “feature information related to the legal issue” refers to values or identifiers obtained by processing user-provided information, such as transaction amounts, dates, contract types, presence or absence of written agreements, and detected clause types, which are used as inputs to a prediction or recommendation model.

The term “likelihood of a favorable judicial outcome” refers to a numerical value or probability score that indicates, from the perspective of a predictive model, a degree of expected success in a judicial or quasi-judicial process for the legal issue of a user.

The term “prediction process” refers to a sequence of computational operations performed by one or more models, such as machine learning models, to calculate an output value, including the likelihood of a favorable judicial outcome, from input feature information.

The term “professional persons in a legal field” refers to human service providers having specialized knowledge or qualifications in law, such as legal practitioners, legal advisors, or legal consultants, who are candidates for referral to the user.

The term “referral information” refers to data that identifies one or more professional persons in a legal field and may include attributes such as specialization, region, availability, and a presentation order for display to the user.

The term “presentation order” refers to an arrangement or ranking of multiple professional persons in a legal field, defined by an order index or sequence, for display or output by the system in accordance with computed suitability or other criteria.

The term “natural language processing” refers to a class of computational techniques that analyze and transform linguistic information, including tokenization, part-of-speech tagging, syntactic parsing, named-entity recognition, and semantic feature extraction.

The term “preprocessing” refers to operations that transform raw input data from a user into data in a normalized or structured form suitable for further processing by models, including cleaning, segmentation, tokenization, and feature extraction.

The term “structured case representation” refers to a data structure generated by preprocessing user-provided information, which encodes legal facts, extracted entities, and other features of a legal issue in a machine-usable, organized format.

The term “instruction information regarding an output format” refers to data elements that specify how a generative AI model should format its response, such as requirements for stepwise guidance, bullet lists, plain-language explanations, or inclusion of risk indicators.

The term “stepwise action guidelines” refers to advice content that indicates actions in an ordered sequence, where each step is delineated so as to guide the user through a process for addressing the legal issue.

The term “risk information” refers to data included in advice content that identifies potential disadvantages, uncertainties, liabilities, or other negative consequences associated with one or more options related to the legal issue.

The term “statistical model” refers to a computational model, including but not limited to regression models, classification models, and ranking models, that is trained using past data and configured to compute quantitative outputs such as suitability degrees.

The term “past consultation cases and outcomes” refers to historical records of interactions between users and professional persons in a legal field, including features of legal issues, actions taken, and resolution results, used as training or reference data for a statistical model.

The term “suitability degree” refers to a numerical value calculated by a statistical model that indicates the appropriateness of a particular professional person in a legal field for a given structured case representation.

The term “user terminal” refers to an electronic device operated by a user, such as a computing device, communication device, or display device, that is capable of transmitting information to and receiving information from the server.

The term “encrypted communication scheme” refers to a protocol or mechanism for securing data transmitted between the server and a user terminal using cryptographic techniques, such as transport-layer encryption, to prevent unauthorized access or modification.

The term “settlement information” refers to data used in connection with payment or billing for services, including payment method identifiers, amounts, and transaction status, which is processed by the system.

The term “online consultation” refers to an electronically mediated interaction between a user and a professional person in a legal field, conducted via a communication network using modalities such as text messaging, audio communication, or video communication.

The term “connection information for the online consultation” refers to data necessary for establishing or accessing an online consultation, such as session identifiers, resource locators, meeting links, or authentication tokens.

The term “adjust” in the context of adjusting a prompt sentence or advice content refers to modifying, augmenting, reordering, or filtering at least part of the content based on one or more parameters, including the emotional state of the user and the characteristics of the legal issue.

The term “learn” in the context of learning an information set refers to training a computational model using the information set as training data so that the model updates internal parameters to represent patterns present in the data.

In one embodiment, a server, a terminal, and a user cooperate to implement the claimed system. The server is realized by one or more computing devices such as rack-mounted servers or virtual machines executing on a data center platform. The server includes at least one general-purpose central processing unit, at least one graphics processing unit, a memory subsystem, and a non-transitory storage device. The server executes system software such as an operating system and middleware, and executes application software implementing natural language processing, machine learning, and communication control for legal support.

The server uses concrete software components to implement the claimed functions. The server uses a machine learning framework such as TensorFlow or PyTorch to construct and train a prediction model and a generative AI model interface. The server uses a natural language processing library such as spaCy to perform tokenization, part-of-speech tagging, named entity recognition, and sentence segmentation. The server optionally uses a transformer-based library such as a generic transformer framework to perform emotion detection and advanced text representations. The server uses a statistical learning library such as a general-purpose machine learning toolkit (for example, a toolkit for regression and ranking models) to build an expert recommendation model. The server uses a database management system such as a relational database server to store case data, model parameters, and expert profiles. The server uses a web server and application framework (for example, a generic HTTP server and an application framework such as a request-routing library) to handle communication with the terminal over an encrypted transport protocol such as HTTPS with TLS.

The server represents a legal issue of the user as a structured case representation. The server allocates memory for this representation as a data structure including multiple fields such as a free-text description, extracted entities (dates, monetary amounts, party identifiers, jurisdictional keywords), contract clause types, and numerical features. The server uses the natural language processing library to convert raw user text into token sequences, to assign syntactic categories, and to detect named entities. The server then maps the detected entities into normalized feature values, such as an integer field indicating the transaction amount in a base currency, a timestamp field representing the date of the transaction, categorical identifiers for contract types, and Boolean flags indicating the presence or absence of specific clauses such as automatic renewal, unilateral termination, jurisdiction, and penalty clauses. The server stores this structured case representation in the memory and optionally writes it to the database.

The server also computes an emotion state of the user from the linguistic information. The server uses an emotion-analysis model that may be implemented by a transformer-based neural network. The neural network may be formed as a sequence of layers including an embedding layer, multiple self-attention layers, and a classification head. The server feeds the tokenized text into the model to obtain a vector of scores corresponding to one or more emotion categories such as anger, anxiety, calmness, and confidence. The server normalizes these scores and applies thresholds to convert them into categorical labels representing the emotional state of the user. The server attaches this emotion state to the structured case representation.

The server uses a prediction model to compute a likelihood of a favorable judicial outcome. The server constructs the prediction model as a deep neural network with, for example, an input layer receiving a feature vector derived from the structured case representation, two or more fully connected hidden layers with nonlinear activation functions such as rectified linear units, and an output layer with a sigmoid activation producing a probability value between zero and one. The server trains this prediction model offline using historical data records representing past cases and their outcomes. During training, the server defines a loss function such as binary cross-entropy between the predicted probability and the actual case outcome, and uses an optimization algorithm such as stochastic gradient descent with adaptive learning rate to update the weights of the network. The server may perform data augmentation on the training set by sampling different subsets of features, normalizing amounts, or slightly perturbing temporal information to increase robustness. After convergence, the server stores the learned weights in the storage device.

At runtime, the server reads the structured case representation, constructs a feature vector including numerical encodings of the entities and clause flags, and passes it through the trained prediction model. The server obtains a scalar representing the likelihood of a favorable judicial outcome and compares this scalar to a threshold value. If the likelihood is greater than the threshold, the server marks the case as eligible for expert referral.

The server also uses a statistical model to compute a suitability degree for each professional person in a legal field. The server implements this model as, for example, a gradient-boosted tree ensemble or a logistic regression model. The server trains this model using past consultation cases and recorded outcomes, where each training sample includes features representing the structured case representation and features representing the professional person such as specialization categories, historical success rates, user ratings, and response times. The server defines an objective function such as a ranking loss or classification loss and updates the model accordingly. The server stores the trained model parameters in the database or file system.

At runtime, the server evaluates, for each professional person stored in the expert profile database, a suitability degree by inputting the combination of the current structured case representation and the profile features into the statistical model. The server modifies the suitability degree by applying weights that depend on the computed likelihood of a favorable judicial outcome and on the emotional state. For example, the server multiplies the suitability degree by a factor dependent on the emotion, increasing the score for experts with high client-care scores when the emotion state indicates anxiety. The server sorts the professional persons according to these weighted suitability degrees and constructs referral information including the ordered list and associated attributes such as specialization, estimated fee range, communication capabilities, and region.

The server generates a prompt sentence for a generative AI model based on the structured case representation and the emotion state. The server maintains one or more prompt templates stored as text patterns. Each template includes placeholders for key facts, jurisdictional information, emotion state description, and output instructions. The server selects a template depending on the function requested by the user, such as general advice, contract risk analysis, or litigation guidance. The server uses the structured case representation to fill the factual placeholders with specific content such as transaction amounts, dates, clause types, and parties. The server uses the emotion state to fill a section describing the user's emotional condition. The server also appends instruction information indicating the desired output format, such as requiring stepwise action guidelines and explicit risk identification.

In one example, the server generates a prompt sentence such as:

“User emotions: anger, anxiety.

Legal issue: The user believes they are a victim of online fraud. Facts: The user paid 50,000 JPY via credit card for Product A on an online marketplace on Jan. 10, 2026; the product has not arrived after 30 days; the seller has not responded to any messages; the platform has declined a refund request.

Jurisdiction: Japan.

Task: Based on typical patterns of case law in similar consumer disputes, explain the likely legal options available to the user, suggest the evidence the user should collect, and provide calm, step-by-step guidance on what the user should do next. Use language understandable by a non-lawyer and avoid encouraging impulsive decisions.”

In another example, the server generates a contract risk-analysis prompt sentence such as:

“Analyze the following service agreement governed by Japanese law. Identify legal risks for the customer, including automatic renewal clauses, penalty clauses, unilateral termination rights, jurisdiction and arbitration clauses, and payment conditions.

Contract text: [full contract text inserted].

Output a concise list of risks with plain-language explanations and practical suggestions for negotiation.”

The server transmits the generated prompt sentence to a generative AI model hosted on the same server or on a cooperating computing resource. The generative AI model is implemented as a neural network with a transformer architecture comprising multiple attention layers, feed-forward layers, and layer normalization components. The server loads pre-trained model parameters that have been trained on large-scale text corpora and optionally fine-tuned on legal text datasets. The server passes the prompt sentence as a token sequence to the generative AI model, and the model performs a sequence of matrix multiplications, attention-score computations, and non-linear transformations to produce a probability distribution over possible next tokens at each position. The server controls generation parameters such as maximum output length and sampling temperature to obtain a response that is sufficiently detailed but bounded in size.

The server receives the output token sequence and converts it into natural-language advice content. The server may perform post-processing steps such as segmenting the output into sections labeled as summary, recommended actions, and risks, or inserting numbering for stepwise guidance. The server may also check for alignment with internal constraints, such as prohibiting certain types of content, and may truncate or filter parts of the response.

The server integrates the advice content with the referral information. When the likelihood of a favorable judicial outcome exceeds the threshold and the user's input indicates interest in professional assistance, the server appends the ranked list of professional persons to the advice content and stores the combined information in a response dataset. The server includes details for each professional person, such as specialization category (e.g., consumer law, family law, traffic accidents), approximate fee ranges, and available communication modes (secure text chat, audio call, video conference).

The server uses a communication module to send the response dataset to the terminal over an encrypted channel. The server configures a web server component to provide an application programming interface that returns structured data to the terminal. The server uses an encrypted communication scheme such as TLS to ensure confidentiality and integrity of the transmitted legal issue information, advice content, referral information, and settlement information. The server also manages a payment subsystem by interfacing with an external payment gateway over an encrypted connection. The server receives payment authorization tokens from the terminal, forwards them to the payment gateway, and receives transaction result data. The server stores transaction identifiers and payment status in the database and associates them with the selected professional person and the structured case representation.

The terminal is implemented as a user-operated computing device such as a smartphone, tablet, laptop computer, or desktop computer. The terminal executes a user interface module as a native application or as a web application displayed in a browser. The terminal presents input fields for user text, file-upload controls for contract documents, and options for selecting the legal category and desired service type. The terminal converts user input into a data structure and sends it to the server using an encrypted communication protocol. The terminal receives the response dataset from the server and renders the advice content and the referral information to the display. The terminal may format the advice content as a multi-section document with easily readable headings and bullet lists. The terminal shows the ranked experts with “contact” buttons. When the user initiates an online consultation, the terminal presents a payment interface and sends the necessary settlement information to the server.

The user interacts with the system by operating the terminal. The user enters descriptions of legal issues, uploads contracts or evidence, reads the generated advice, reviews suggested experts, and decides whether to initiate an online consultation. The user may select a communication modality such as text chat or video conference, and the terminal uses connection information supplied by the server to establish a real-time communication session with the selected professional person.

The described arrangement provides improvements in computer technology beyond a mere automation of human tasks. The server uses the structured case representation and the emotion state to control the internal data flow between modules and to condition the behavior of the generative AI model and the statistical models. By converting free-form text into a compact feature vector and case representation, the server reduces the dimensionality of the data that must be consumed by prediction and recommendation modules, thereby reducing computational load and improving processing speed. By applying emotion-dependent weighting in the expert recommendation model, the server reduces unnecessary recommendations and subsequent network communication, thereby reducing communication load and improving resource utilization.

Because the server uses learned parameters from the information set including judicial decision information, the server can identify patterns and correlations that human operators or simple rule-based systems cannot feasibly derive in real time. The server's neural network models perform high-dimensional matrix operations that take into account subtle combinations of features, leading to improved accuracy in the predicted likelihood of favorable judicial outcomes and in the suitability degrees of experts. The server also reduces error rates in advice generation by providing the generative AI model with a carefully structured prompt sentence that includes both factual features and instruction information, which stabilizes the output distribution and avoids repetitive or irrelevant text. This improves the efficiency of the generative AI model and reduces the need for multiple revisions, resulting in lower CPU usage and lower latency.

The system uses non-conventional integration of separate computational components. The server does not simply collect, store, and display information. Instead, the server orchestrates a sequence of specific transformations: raw text to structured case representation; structured case representation to feature vectors; feature vectors to probability values and suitability degrees; case representation and emotion state to a prompt sentence; prompt sentence to advice content; and advice content and suitability degrees to a unified response. Each transformation uses specific algorithms and data structures that are tuned to the properties of legal texts and emotion signals. The coordinated design of these modules produces technical effects such as improved throughput of legal support sessions, reduced average response time per case, and improved distribution of computational load across server resources.

The server can implement alternative embodiments and variations. In one variation, the server uses a recurrent neural network or a convolutional neural network as the prediction model instead of a fully connected network. In another variation, the server uses a different loss function during training, such as a focal loss to handle imbalanced datasets of favorable and unfavorable outcomes. In another variation, the server uses a different ranking algorithm, such as a pairwise ranking model or a listwise ranking model, for expert recommendation. In yet another variation, the server uses different emotion categories or continuous emotion vectors and adjusts the prompt sentence and expert ranking according to different mapping rules.

In a further embodiment, the server may store multiple generative AI models optimized for different legal domains or jurisdictions. The server may select a particular generative AI model or parameter set based on the detected jurisdiction in the structured case representation, thereby reducing the required output length and increasing relevance, which further reduces processing time and communication bandwidth. In another embodiment, the server may implement caching of partial analysis results, such as storing computed structured case representations and emotion states for ongoing sessions, so that subsequent advice requests use existing processed data without repeating all computations.

Because the system defines concrete data structures, explicit neural network architectures, training procedures, and interaction protocols between modules, the invention provides specific improvements to the functioning of the computer system itself. The server achieves more efficient memory usage and CPU/GPU utilization through the structured representation and modular processing pipeline, and reduces network load by avoiding redundant data transfers and by tailoring responses to the specific needs and emotional context of the user. These technical effects, including enhanced calculation efficiency, reduced latency, improved prediction accuracy, and optimized communication, arise from the specific configuration and operation of the server, terminal, and models, rather than from a mere automation of pre-existing human decision-making.

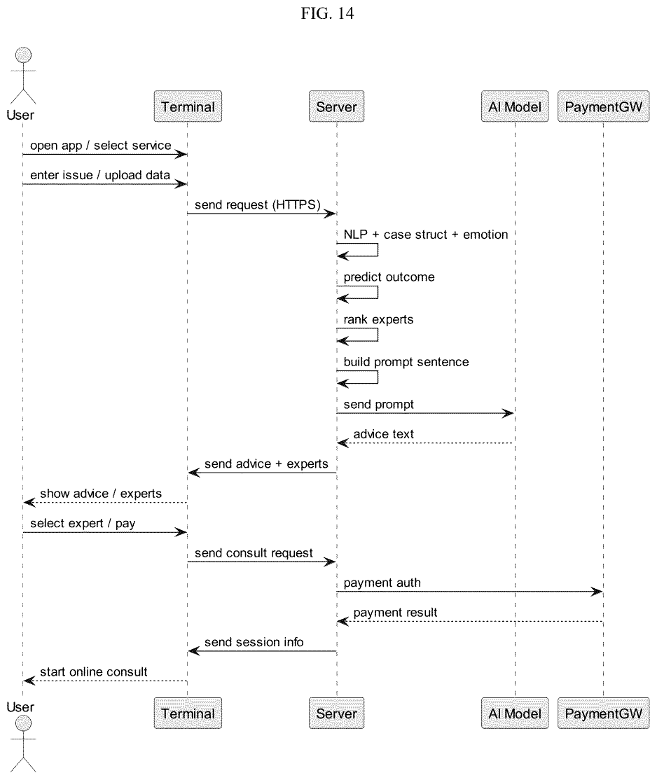

The following describes the processing flow using FIG. 14.

### Step 1:

User operates the terminal to start a legal support session.
User opens an application or web page on the terminal and selects a function such as “general legal question,” “dispute about online transaction,” or “contract risk check.”
Input: user selections on the user interface.
Output: a selected function type stored in the terminal's session state.

### Step 2:

User inputs legal information into the terminal.
User types a free-text description of the legal issue, optionally uploads contract files or evidence images, and may enter attributes such as jurisdiction and transaction amount.
Input: user text, file selections, and option selections.
Output: a local data structure on the terminal including raw text, file references, and option values.

### Step 3:

Terminal packages user data for transmission.
Terminal converts the local data structure into a request object, typically JSON, and attaches metadata such as timestamps and session identifiers.
Input: raw user data (text, files, options).
Output: a serialized request object prepared for network transmission.

### Step 4:

Terminal transmits the request to the server using encrypted communication.
Terminal establishes an HTTPS connection using TLS, creates an HTTP request (for example, POST/legal-support), attaches the serialized request object in the body, and sends it to the server.
Input: serialized request object and server endpoint information.
Output: an encrypted network packet stream sent to the server.

### Step 5:

Server receives and validates the request.
Server terminates TLS, parses HTTP headers, deserializes the JSON body, and checks for required fields such as description, function type, and user identifier. The server rejects or truncates data exceeding size limits.
Input: encrypted network packets containing the request object.
Output: a validated internal representation of the user request; if invalid, an error response.

### Step 6:

Server performs natural language preprocessing on the user text.
Server extracts the text fields (description, contract text, transaction notes) and uses a natural language processing library to tokenize the text, assign part-of-speech tags, and perform named entity recognition to identify dates, amounts, parties, locations, and clause keywords.
Input: raw text fields from the validated request.
Output: token sequences, syntactic tags, and a list of detected entities.

### Step 7:

Server builds a structured case representation.
Server maps detected entities and syntactic information into a data structure containing normalized fields such as numerical amounts, timestamps, categorical contract types, Boolean flags for specific clause types, and a cleaned summary of the issue. The server stores this structure in memory for subsequent modules.
Input: token sequences and detected entities.
Output: a structured case representation describing the legal issue in machine-usable form.

### Step 8:

Server analyzes the user's emotional state.
Server passes the original or preprocessed text to an emotion-analysis model, computes emotion scores for categories such as anger and anxiety, normalizes these scores, and converts them into one or more categorical emotion labels based on threshold rules.
Input: user text and model parameters for emotion analysis.
Output: a quantified emotion state associated with the user (for example, anger-high, anxiety-medium).

### Step 9:

Server predicts the likelihood of a favorable judicial outcome.
Server converts the structured case representation into a feature vector by encoding numeric and categorical values, feeds this vector into a trained neural-network prediction model, and performs a forward pass to obtain a probability value. Server compares this value to a stored threshold and flags the case as eligible or not eligible for expert referral.
Input: structured case representation and prediction model parameters.
Output: a numerical likelihood of a favorable judicial outcome and a binary eligibility flag.

### Step 10:

Server computes suitability degrees for professional persons.
Server queries an expert profile database to retrieve candidate professionals, constructs feature vectors combining the structured case representation with expert attributes (specialization, region, performance indicators), and inputs these vectors into a trained statistical model. The server calculates a suitability degree for each expert and then adjusts each degree by applying weights that depend on the likelihood of a favorable outcome and the emotion state.
Input: structured case representation, expert profiles, and statistical model parameters.
Output: weighted suitability degrees for a set of experts.

### Step 11:

Server generates referral information based on the suitability degrees.
Server sorts the experts by their weighted suitability degrees, selects a subset of top-ranked experts, and constructs a referral list containing identifiers, specialties, approximate fee ranges, and available communication modes. The server defines a presentation order corresponding to the sorted ranking.
Input: weighted suitability degrees and expert profile data.
Output: referral information including an ordered list of recommended experts.

### Step 12:

Server constructs a prompt sentence for a generative AI model.
Server selects a prompt template based on the function type, fills placeholders with key facts from the structured case representation (transaction amount, relevant dates, contract clauses, jurisdiction) and a description of the user's emotion state, and appends instruction phrases specifying the desired output style, such as stepwise guidance and risk explanation. The server concatenates these components into a single prompt sentence.
Input: structured case representation, emotion state, and prompt templates.
Output: a text-based prompt sentence ready for submission to a generative AI model.

### Step 13:

Server sends the prompt sentence to the generative AI model and obtains advice content.
Server forwards the prompt sentence to a generative AI model interface, invokes text generation with specified parameters such as maximum length and sampling temperature, and receives a generated token sequence. The server decodes the token sequence into natural-language text and performs optional formatting into sections such as summary, recommended actions, and risks.
Input: prompt sentence and generative AI model parameters.
Output: natural-language advice content describing possible actions, implications, and risks.

### Step 14:

Server assembles a response object for the terminal.
Server combines the advice content, the numerical likelihood of a favorable outcome, and the expert referral information into a unified response structure. The server may also add disclaimers and identifiers for follow-up processing. The response is serialized into a format suitable for transmission.
Input: advice content, prediction results, and referral information.
Output: a serialized response object containing all relevant output data.

### Step 15:

Server transmits the response to the terminal using encrypted communication.
Server sends the serialized response over an HTTPS connection, relying on TLS to protect confidentiality and integrity. The server includes appropriate status codes and headers indicating successful processing.
Input: serialized response object and terminal connection information.
Output: encrypted network packets delivering the response to the terminal.

### Step 16:

Terminal receives and parses the response.
Terminal reads the HTTP response, verifies successful status, and deserializes the body into a local data structure. The terminal extracts fields such as advice text, victory likelihood, and expert list.
Input: encrypted response packets from the server.
Output: parsed response data held in terminal memory.

### Step 17:

Terminal presents advice and referral information to the user.
Terminal formats the advice text for display, for example as paragraphs and numbered steps, renders the victory likelihood as a percentage or bar indicator, and shows the ordered list of experts with relevant attributes and “contact” controls.
Input: parsed response data.
Output: a user interface view containing legal advice, outcome estimation, and expert options.

### Step 18:

User reviews the information and optionally selects an expert.
User reads the advice, considers the victory likelihood, and, if desired, selects an expert from the referral list and chooses a consultation mode such as secure chat or video call.
Input: displayed advice and expert list.
Output: a user selection of an expert and consultation mode stored on the terminal.

### Step 19:

Terminal initiates a consultation request and payment preparation.
Terminal creates a new request including the selected expert identifier, consultation mode, and necessary payment or settlement information, and sends this request to the server via HTTPS.
Input: user selection and payment details.
Output: an encrypted consultation initiation request sent to the server.

### Step 20:

Server processes the consultation request and executes settlement.
Server receives the consultation request, validates the expert identifier and requested mode, and forwards payment-related data to a payment gateway using an encrypted protocol. Server receives approval or failure status, records the transaction in its database, and generates connection information for the online consultation such as a session identifier or meeting link.
Input: consultation initiation request and payment gateway response.
Output: payment status and consultation connection information.

### Step 21:

Server returns consultation connection information to the terminal.
Server builds a response containing the payment result and the data required to establish the online consultation and transmits it over the encrypted channel to the terminal.
Input: payment status and connection information.
Output: a serialized response containing consultation connection data.

### Step 22:

Terminal establishes the online consultation session.
Terminal parses the connection information, invokes appropriate communication components such as a secure chat client or video conferencing module, and connects to the expert's endpoint.
Input: consultation connection data.
Output: an active communication channel between the user and the expert.

### Step 23:

User conducts the online consultation using the terminal.
User exchanges messages, audio, or video with the expert through the established channel, relying on the terminal's interface and communication stack to manage real-time data transfer.
Input: user interactions and expert responses.
Output: ongoing consultation data streams and, ultimately, resolution or further actions determined outside the server's automated processing.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

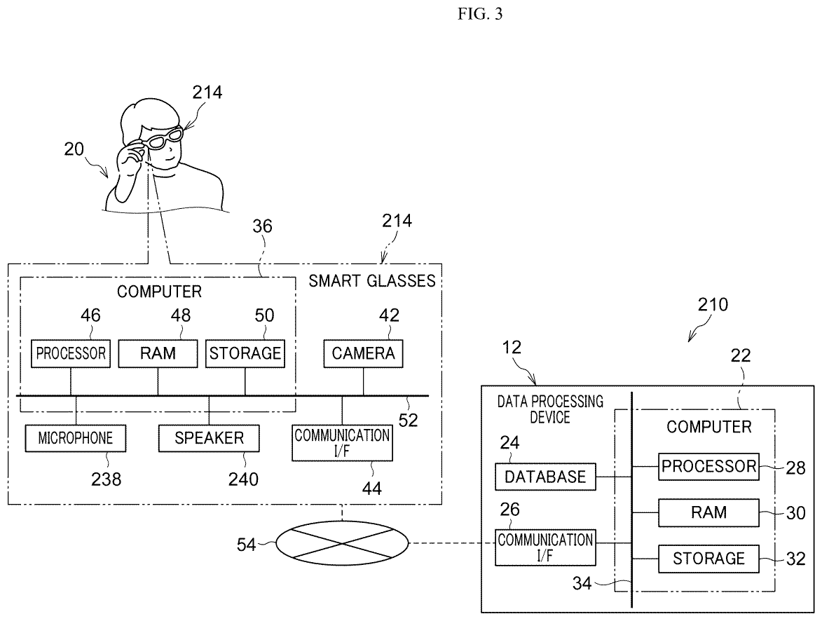

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

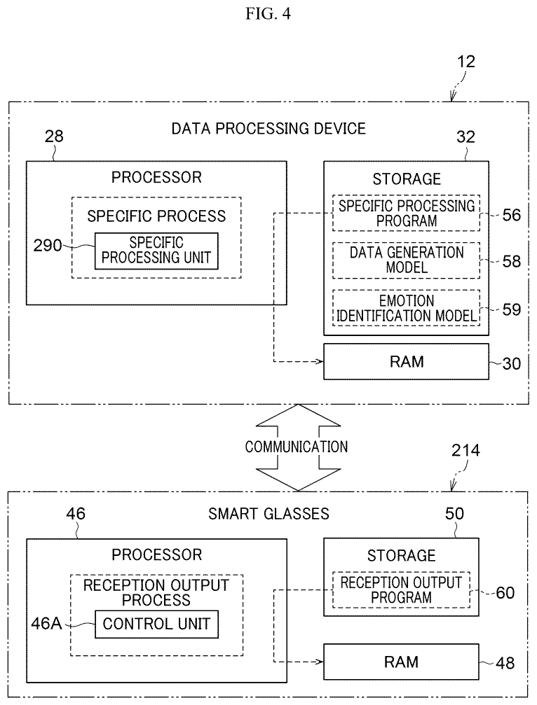

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

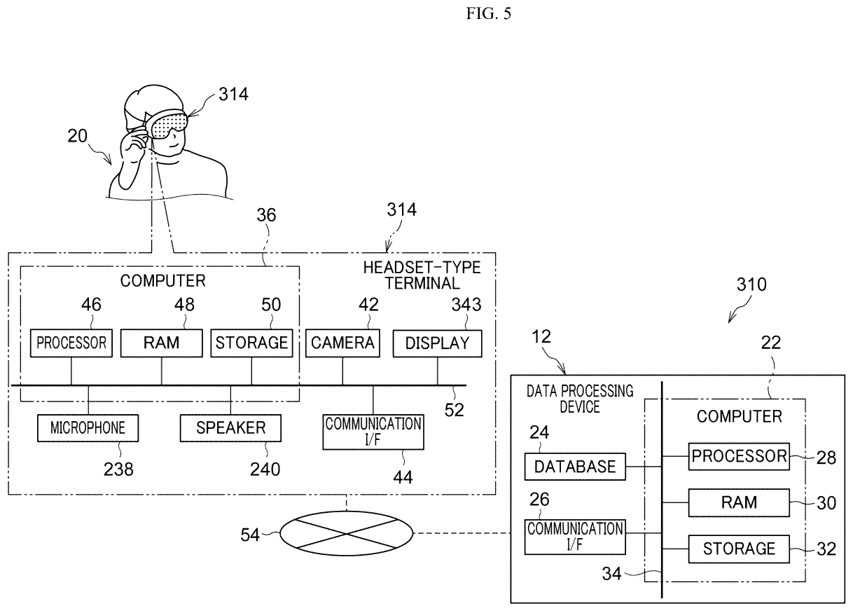

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

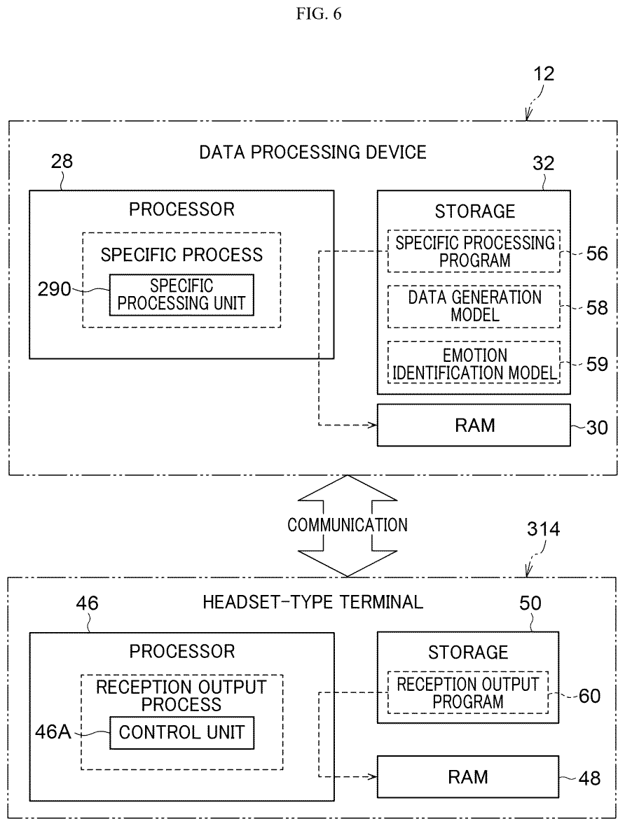

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

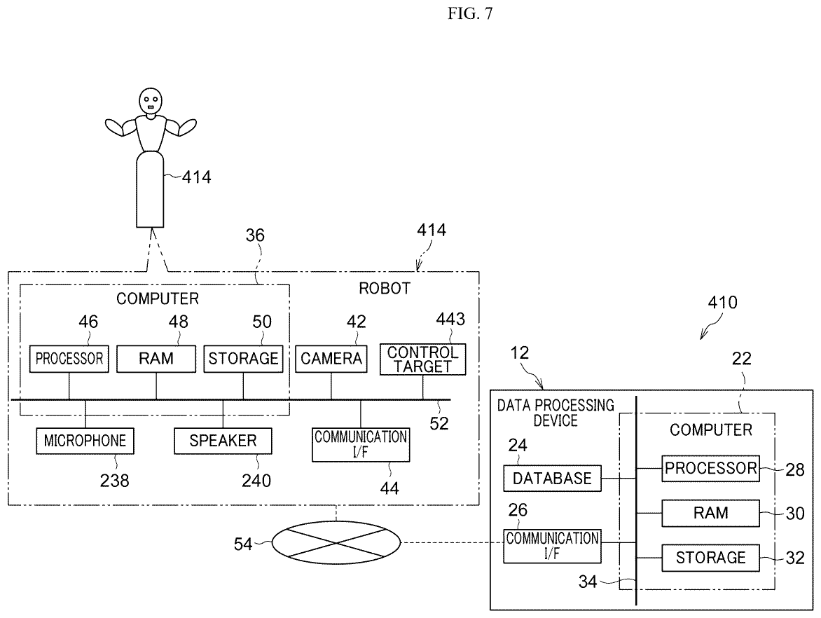

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

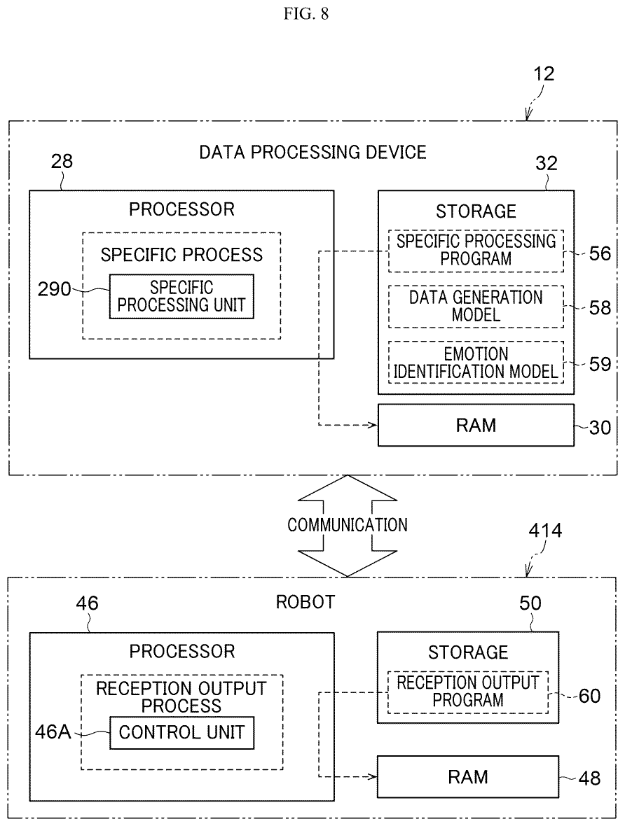

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

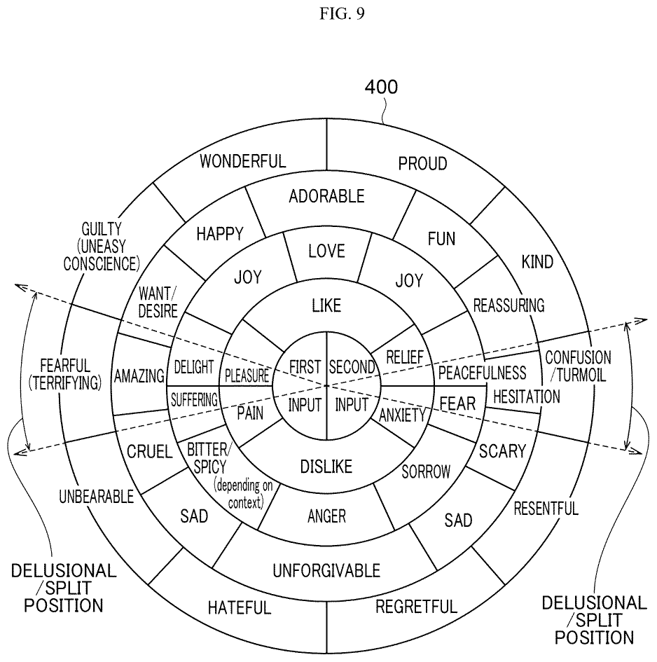

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

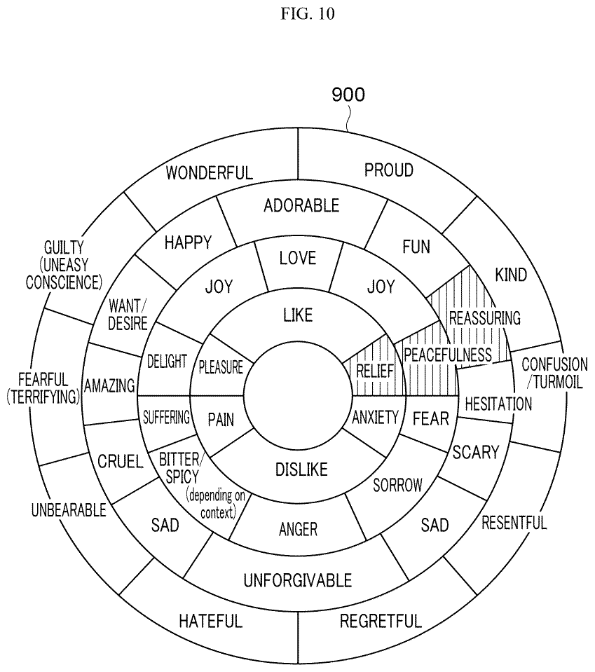

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
obtain, from a storage unit, a group of information including document information comprising past judicial decisions as learning information, and train a generative AI model based on a statistical learning method by using a machine learning platform so as to generate legal knowledge representations based on the document information comprising the past judicial decisions,
receive, via a communication terminal, explanation information in natural language regarding a legal issue input by a user, normalize the explanation information by using a natural language processing technique, divide the explanation information into units of words or subwords, extract important words and important phrases, convert the explanation information into a numerical representation, and classify a legal field category corresponding to the explanation information,
retrieve, on the basis of the numerical representation, a plurality of related judicial decision information by using similarity between the numerical representation and numerical representations stored in association with the document information comprising the past judicial decisions, and generate a prompt sentence including summary information of the related judicial decision information, the legal field category, and the explanation information of the user,
input the generated prompt sentence as input information to the generative AI model, cause the generative AI model to generate a response sentence including advice information regarding the legal issue of the user, evaluate a legal risk or a dispute complexity on the basis of the response sentence and the explanation information, and, when a predetermined condition is satisfied, obtain expert information from a legal practitioner information storage unit that stores information of legal practitioners having a professional qualification and add the expert information to the advice information, and
transmit, to the communication terminal, response information including the response sentence and the expert information by encrypted communication, and cause the communication terminal to present the response information to the user.

### (Supplementary 2)

The system according to supplementary 1,
wherein the processor is configured to define, in generating the prompt sentence, a prompt sentence structure including the important words extracted from the explanation information, the legal field category, the summary information of the related judicial decision information, and constraint conditions regarding a response format, and dynamically generate the prompt sentence for input to the generative AI model according to the prompt sentence structure so as to control content and expression style of the advice information.

### (Supplementary 3)

The system according to supplementary 1,
wherein the processor is configured to perform an emotional state estimation process on the explanation information based on an emotion analysis technique, change instruction content in the prompt sentence regarding a response tone or a level of explanation detail according to an estimated emotional state, and adjust the expression style of the advice information generated by the generative AI model according to the emotional state.

### Application Example 1

### (Supplementary 1)

A system comprising a processor,
wherein the processor is configured to
learn an information set including court-related information and configure a generative AI model that receives inquiry information regarding a legal problem of a user as input, preprocess character information regarding the legal problem received from a terminal of the user by using natural language processing technology, the preprocessing including tokenizing a sequence of words, extracting important terms, and normalizing the information, generate a prompt sentence including the preprocessed character information and the important terms extracted from the character information, and input the prompt sentence to the generative AI model to generate legal advice information,
perform similarity calculation based on the character information regarding the legal problem or the preprocessed character information, acquire reference case information with high relevance from a past case information set, and add summary information of the reference case information to the prompt sentence or to the legal advice information,
analyze an emotional state of the user and adjust an expression content or a presentation format of the legal advice information according to the emotional state, transmit the legal advice information and the summary information of the reference case information to the terminal of the user via a communication path and cause the terminal of the user to present the legal advice information, and
when a condition that a litigation success possibility is determined to be high is satisfied, identify a legal professional having specialized knowledge suitable for the legal problem and present introduction information of the legal professional to the user.

### (Supplementary 2)

The system according to supplementary 1,
wherein the processor is configured to analyze character information including a situation description from the user by using natural language processing technology to generate structured information, generate candidate solution information by the generative AI model based on the structured information and the information set including the court-related information, and select or modify the candidate solution information based on the emotional state of the user and the reference case information to present the candidate solution information as the legal advice information.

### (Supplementary 3)

The system according to supplementary 1,
wherein the processor is configured to
encrypt communication data and stored data by using an encryption scheme and perform access control by authentication processing in order to protect the inquiry information, the legal advice information, and information regarding the reference case information transmitted and received between the terminal of the user and the system.

### Example 2

### (Supplementary 1)

A system comprising a processor,
wherein the processor is configured to
learn an information set including multiple legal case records, and generate a prompt sentence for a generative AI model by using text information including information on a legal issue of a user entity and explanation information based on the text information, and input the prompt sentence to the generative AI model so as to cause the generative AI model to output an evaluation value indicating a winning possibility with respect to the legal issue and explanation information relating to the evaluation value,
process information acquired from the user entity via a communication terminal, the information including case outline information, related party information, evidence information, and situation description information, by performing structuring, format conversion, preprocessing, and conversion into a token sequence so that the information is converted into a format suitable for processing by the generative AI model,
extract numerical information indicating the winning possibility from text information output from the generative AI model, compare the numerical information with a predetermined reference value, and determine whether the winning possibility is equal to or greater than the reference value,
search, based on a determination result, when the winning possibility is determined to be equal to or greater than the reference value, for a legal professional suitable for the legal issue from a professional information set including field information, region information, and evaluation information, and generate recommendation information for recommending the legal professional to the user entity, and
generate output information, which is displayable on the communication terminal, including input information acquired from the user entity, the evaluation value, the explanation information, and the recommendation information relating to the legal professional, and transmit the output information to the communication terminal via a communication path.

### (Supplementary 2)

The system according to supplementary 1,
wherein the processor is configured to
generate the prompt sentence as natural language text including an instruction sentence in which structured data including a type of the legal issue, a type of judicial procedure, and information relating to factual circumstances of a case is embedded, and input the prompt sentence and the structured data to the generative AI model in parallel so as to cause the generative AI model to output the evaluation value indicating the winning possibility as a percentage.

### (Supplementary 3)

The system according to supplementary 1,
wherein the processor is configured to
protect the information by executing information protection processing including encryption processing when transmitting and receiving the information acquired from the user entity and output information from the generative AI model via the communication path.

### Application Example 2

### (Supplementary 1)

A system comprising a processor,
wherein the processor is configured to learn an information set including judicial decision information and generate a prompt sentence to be input to a generative AI model in order to generate advice for a legal issue of a user, and
analyze linguistic information acquired from the user to identify an emotional state of the user, and adjust at least one of the prompt sentence to be input to the generative AI model and advice content obtained from the generative AI model in accordance with the identified emotional state, and
execute a prediction process that numericalizes a likelihood of a favorable judicial outcome based on feature information related to the legal issue of the user, extract, when the likelihood satisfies a predetermined criterion, candidates of professional persons in a legal field having expert knowledge, and generate referral information in which a presentation order of the professional persons is adjusted in accordance with the emotional state of the user and contents of the legal issue, and
perform preprocessing by natural language processing on information related to the legal issue transmitted from a terminal of the user to generate a structured case representation, transmit to the generative AI model the prompt sentence including the case representation and the emotional state, and transmit advice information obtained from the generative AI model as a response together with the referral information to the terminal of the user, and protect information related to the legal issue and settlement information by using an encrypted communication scheme when transmitting and receiving the information to and from the terminal of the user, and execute a settlement process related to an online consultation with the professional person and provide connection information for the online consultation.

### (Supplementary 2)

The System According to Supplementary 1,
wherein the processor is configured to
convert information including a description of the legal issue acquired from the user, transaction conditions, contract provisions, and user attributes into the structured case representation by performing preprocessing, combine the case representation with the emotional state and instruction information regarding an output format to construct the prompt sentence, and acquire, from the generative AI model, advice information including stepwise action guidelines and risk information based on the prompt sentence.

### (Supplementary 3)

The system according to supplementary 1,
wherein the processor is configured to
calculate, by a statistical model constructed based on past consultation cases and outcomes, a suitability degree of each professional person using the structured case representation as an input, and select the professional persons based on the referral information generated from the suitability degree weighted in accordance with the likelihood of a favorable judicial outcome and the emotional state, and generate the referral information.

What is claimed is:

1. A system comprising:
circuitry configured to:
obtain, from a storage device, document data comprising past decision records as training data, and train a generative neural network model using a statistical learning algorithm to generate internal knowledge representations corresponding to the document data;
receive, via a communication interface coupled to a packet-switched network, natural language description data from a terminal device, normalize the description data, segment the description data into word or subword units, extract important words and important phrases, convert the description data into a numerical vector representation using a natural language processing algorithm, and classify a domain category corresponding to the description data;
retrieve, based on the numerical vector representation, a plurality of related decision record information from the storage device using similarity between the numerical vector representation and stored numerical vector representations associated with the document data, generate summary data of the related decision record information, and construct a prompt sentence comprising the important words, the domain category, the summary data, and constraint conditions specifying a response format;
input the prompt sentence to the generative neural network model, receive a response sentence comprising advice data, evaluate a risk metric or a complexity metric from at least the response sentence and the numerical vector representation, and when the risk metric or the complexity metric satisfies a predetermined condition, append expert data retrieved from a practitioner data store to the advice data; and
apply an emotion estimation algorithm to the description data to generate an emotion state parameter, modify at least one of a response tone instruction or an explanation detail level instruction in the prompt sentence based on the emotion state parameter, and transmit response data comprising the response sentence and, when retrieved, the expert data to the terminal device via an encrypted communication channel.

2. The system according to claim 1, wherein the circuitry is configured to apply a subword tokenizer to the description data to generate token sequences, apply an embedding model to the token sequences to generate the numerical vector representation, and store the numerical vector representation in a vector index in the storage device indexed by a document identifier.

3. The system according to claim 2, wherein the circuitry is configured to apply an approximate nearest-neighbor search algorithm to the vector index to retrieve the plurality of related decision record information ranked by cosine similarity between the numerical vector representation and stored numerical vector representations, and select a subset of the plurality of related decision record information ranked above a similarity threshold.

4. The system according to claim 3, wherein the circuitry is configured to generate the summary data by applying an extractive summarization algorithm to each item in the selected subset to identify key passages, and concatenate the key passages from each item to form a structured summary for incorporation into the prompt sentence.

5. The system according to claim 4, wherein the circuitry is configured to construct the prompt sentence by selecting a prompt template based on the domain category, substituting the important words, the summary data, and the emotion state parameter into the prompt template, and appending constraint conditions specifying a maximum response length and an explanation formality level.

6. The system according to claim 5, wherein the circuitry is configured to apply a risk scoring algorithm to the response sentence and the numerical vector representation to compute the risk metric, apply a complexity scoring algorithm to the response sentence to compute the complexity metric, compare the risk metric and the complexity metric against respective predetermined thresholds, and trigger retrieval of expert data when either threshold is exceeded.

7. The system according to claim 6, wherein the circuitry is configured to retrieve expert data from the practitioner data store by applying a matching algorithm that selects practitioner records based on the domain category and availability data stored in the practitioner data store, rank the selected practitioner records by a suitability score, and append data for the highest-ranked practitioner record to the advice data.

8. The system according to claim 1, wherein the circuitry is configured to apply an emotion classification model to the description data to classify the emotion state parameter into one of a plurality of emotional state categories, select a tone adjustment strategy from a plurality of tone adjustment strategies based on the classified emotional state category, and incorporate the selected tone adjustment strategy as a response tone instruction in the prompt sentence.

9. The system according to claim 8, wherein the circuitry is configured to detect a change in the emotion state parameter exceeding a state-change threshold, regenerate the prompt sentence incorporating the updated emotion state parameter, and supply the regenerated prompt sentence to the generative neural network model to generate updated advice data.

10. The system according to claim 1, wherein the circuitry is configured to train the generative neural network model by applying a statistical learning algorithm to a training dataset comprising numerical vector representations and associated response sequences derived from the document data, update parameters of the generative neural network model by backpropagation using a cross-entropy loss function, and store the updated parameters in the storage device.

11. The system according to claim 10, wherein the circuitry is configured to apply an incremental training algorithm that periodically samples newly received description data and associated response data to construct supplemental training batches, update parameters of the generative neural network model using the supplemental training batches, and store the updated parameters in the storage device.

12. The system according to claim 1, wherein the circuitry is configured to receive follow-up description data from the terminal device extending a prior description, construct an extended input sequence by prepending prior description data and prior response sentence data to the follow-up description data, apply the natural language processing algorithm to the extended input sequence, and regenerate the prompt sentence incorporating the extended input sequence.

13. The system according to claim 12, wherein the circuitry is configured to truncate the extended input sequence to a maximum context length, apply the embedding model to the truncated extended input sequence to generate an updated numerical vector representation, and retrieve updated related decision record information from the storage device using the updated numerical vector representation.

14. The system according to claim 1, wherein the circuitry is configured to store, in the storage device, a history of description data, numerical vector representations, prompt sentences, response sentences, and emotion state parameters indexed by a session identifier, and supply stored history data as context in subsequent prompt sentence construction to maintain response consistency across a session.

15. The system according to claim 14, wherein the circuitry is configured to apply a data retention policy to the stored history data by removing session records older than a predetermined retention period, and apply a compression algorithm to records within the retention period to reduce storage device utilization.

16. The system according to claim 1, wherein the circuitry is configured to compute a confidence score for the response sentence by applying a consistency evaluation algorithm that measures alignment between the response sentence and the retrieved related decision record information, flag response sentences with a confidence score below a minimum threshold, and regenerate flagged response sentences by supplying a revised prompt sentence to the generative neural network model.

17. The system according to claim 1, wherein the circuitry is configured to encrypt the response data using an encryption algorithm prior to transmission, and establish the encrypted communication channel with the terminal device using a key exchange protocol.

18. A system comprising:
circuitry configured to:
receive, via a communication interface coupled to a packet-switched network, natural language description data from a terminal device, convert the description data into a numerical vector representation, and classify a domain category;
retrieve related decision record information from a storage device using similarity-based search on the numerical vector representation, generate summary data from the retrieved information, and construct a prompt sentence comprising the numerical vector representation, the domain category, the summary data, and constraint conditions;
input the prompt sentence to a generative neural network model, receive a response sentence, evaluate a risk metric and a complexity metric, and append expert data from a practitioner data store when either metric exceeds a predetermined threshold; and
apply an emotion estimation algorithm to the description data to generate an emotion state parameter, modify response tone or explanation detail instructions in the prompt sentence based on the emotion state parameter, and transmit response data to the terminal device via an encrypted communication channel.

19. The system according to claim 18, wherein the circuitry is configured to apply an approximate nearest-neighbor search algorithm to retrieve related decision record information ranked by cosine similarity, select a subset above a similarity threshold, and incorporate key passages from the selected subset into the prompt sentence as summary data.

20. A method performed by circuitry, the method comprising:
obtaining, from a storage device, document data comprising past decision records as training data, and training a generative neural network model using a statistical learning algorithm to generate internal knowledge representations corresponding to the document data;
receiving, via a communication interface coupled to a packet-switched network, natural language description data from a terminal device, normalizing the description data, segmenting the description data into word or subword units, extracting important words and important phrases, converting the description data into a numerical vector representation using a natural language processing algorithm, and classifying a domain category corresponding to the description data;
retrieving, based on the numerical vector representation, a plurality of related decision record information from the storage device using similarity between the numerical vector representation and stored numerical vector representations associated with the document data, generating summary data of the related decision record information, and constructing a prompt sentence comprising the important words, the domain category, the summary data, and constraint conditions specifying a response format;
inputting the prompt sentence to the generative neural network model, receiving a response sentence comprising advice data, evaluating a risk metric or a complexity metric from at least the response sentence and the numerical vector representation, and when the risk metric or the complexity metric satisfies a predetermined condition, appending expert data retrieved from a practitioner data store to the advice data; and
applying an emotion estimation algorithm to the description data to generate an emotion state parameter, modifying at least one of a response tone instruction or an explanation detail level instruction in the prompt sentence based on the emotion state parameter, and transmitting response data comprising the response sentence and, when retrieved, the expert data to the terminal device via an encrypted communication channel.
